(19) United States
(12) Patent Application Publication
(10) Pub. No.: US 2026/0350329 A1
(43) Pub. Date: Nov. 5, 2026

(54) IDENTIFICATION TAG MANAGEMENT SYSTEM

(71) Applicant: Pascal Tags Inc., Louisville, KY (US)

(72) Inventors: Brandon Thomas Young, Louisville, KY (US); Daniel George Woodruff, Louisville, KY (US)

(21) Appl. No.: 19/668,371

(22) Filed: May 5, 2026

Related U.S. Application Data
(60) Provisional application No. 63/800,117, filed on May 5, 2025.

(51) Int. Cl. G06K 7/10; G06K 19/07

(52) U.S. Cl. CPC G06K 7/10366; G06K 19/0723

(57) ABSTRACT

One variation of a system includes an identification tag configured to: broadcast a first response signal responsive to excitation by a first interrogation signal at a first incident angle; and broadcast a second response signal responsive to excitation by a second interrogation signal at a second incident angle different from the first incident angle. The identification tag includes: a first target resonator including a first volume of material and a second volume of material cooperating to shift a first target signal characteristic of the first response signal from a first baseline signal characteristic of the first target resonator; and a second target resonator arranged concentrically about the first target resonator and including a third volume of material and a fourth volume of material cooperating to shift a second target signal characteristic of the second response signal from a second baseline signal characteristic of the second target resonator.

### STATEMENT OF GOVERNMENT INTEREST

This invention was made with government support under Contract No. 2136796 awarded by the National Science Foundation. The government has certain rights in the invention.

### CROSS-REFERENCE TO RELATED APPLICATIONS

This Application claims the benefit of U.S. Provisional Application No. 63/800,117, filed on 05-MAY-2025, which is incorporated in its entirety by this reference.

### TECHNICAL FIELD

This invention relates generally to the field of identification tags and, more specifically, to a new and useful method for detecting and managing identification tags.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method;

FIG. 5 is a flowchart representation of one variation of the method; and

FIGS. 6A, 6B, and 6C, are schematic representations of a system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 8. System

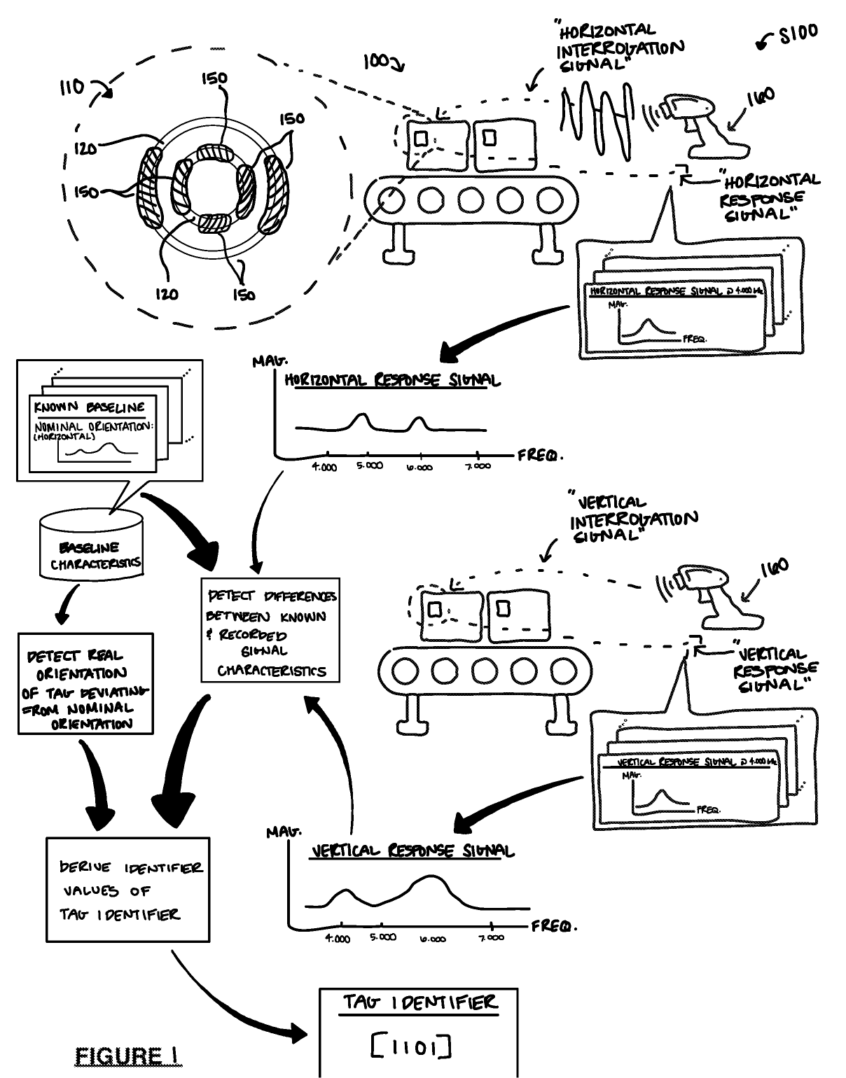

As shown in FIGS. 1-5 and 6A-6C, an identification tag 110 includes a first target resonator 120 and a second target resonator 120 and is configured to: broadcast a horizontally-polarized response signal responsive to excitation by a horizontally-polarized interrogation signal; and broadcast a vertically-polarized response signal responsive to excitation by a vertically-polarized interrogation signal.

The first target resonator 120 includes: a first arc segment intersecting a vertical axis; a second arc segment opposite the first arc segment and intersecting the vertical axis; a first volume of material 150 arranged proximal the first arc segment; and a second volume of material 150 arranged proximal the second arc segment and configured to cooperate with the first volume of material 150 to shift a first target signal characteristic of the horizontally-polarized response signal from a first baseline signal characteristic of the first target resonator 120.

The second target resonator 120 is arranged concentrically about the first target resonator 120 and includes: a third arc segment intersecting a horizontal axis; a fourth arc segment opposite the third arc segment and intersecting the horizontal axis; a third volume of material 150 arranged proximal the third arc segment; and a fourth volume of material 150 arranged proximal the fourth arc segment and configured to cooperate with the third volume of material 150 to shift a second target signal characteristic of the vertically-polarized response signal from a second baseline signal characteristic of the second target resonator 120.

### 8.3 Variation: Dual-Resonator, Dual-Polarization Identification Tag

As shown in FIGS. 1-5 and 6A-6C, one variation of an identification tag 110 includes: a first target resonator 120; and a second target resonator 120. The first target resonator 120 includes: a first arc segment intersecting a first axis; a second arc segment opposite the first arc segment and intersecting the first axis; a first volume of material 150 arranged proximal the first arc segment; and a second volume of material 150 arranged proximal the second arc segment and cooperating with the first volume of material 150 to shift a first baseline signal characteristic of the first target resonator 120.

The second target resonator 120 is arranged concentrically about the first target resonator 120 and includes: a third arc segment intersecting a second axis angularly offset from the first axis; a fourth arc segment opposite the third arc segment and intersecting the second axis; a third volume of material 150 arranged proximal the third arc segment; and a fourth volume of material 150 arranged proximal the fourth arc segment and cooperating with the third volume of material 150 to shift a second baseline signal characteristic of the second target resonator 120.

### 8.4 Variation: Single-Resonator Dual-Polarization Encoding

As shown in FIGS. 1, 2, 5, and 6A, one variation of an identification tag 110 includes a target resonator 120 including: a first volume of material 150; a second volume of material 150; a third volume of material 150; and a fourth volume of material 150. The identification tag 110 is configured to: broadcast a horizontally-polarized response signal responsive to excitation by a horizontally-polarized interrogation signal; and broadcast a vertically-polarized response signal responsive to excitation by a vertically-polarized interrogation signal.

The first volume of material 150 is arranged proximal a first arc segment of the target resonator 120, the first arc segment intersecting a first axis. The second volume of material 150 is: arranged proximal a second arc segment of the target resonator 120, the second arc segment intersecting the first axis; and configured to cooperate with the first volume of material 150 to shift a first target signal characteristic of the horizontally-polarized response signal from a first baseline signal characteristic of the target resonator 120. The third volume of material 150 is arranged proximal a third arc segment of the target resonator 120, the third arc segment intersecting a third axis offset from the first axis. The fourth volume of material 150 is: arranged proximal a fourth arc segment of the target resonator 120, the fourth arc segment intersecting the third axis; and configured to cooperate with the third volume of material 150 to shift a second target signal characteristic of the vertically-polarized response signal from a second baseline signal characteristic of the target resonator 120.

### 8.5 Variation: Nested Square Resonators

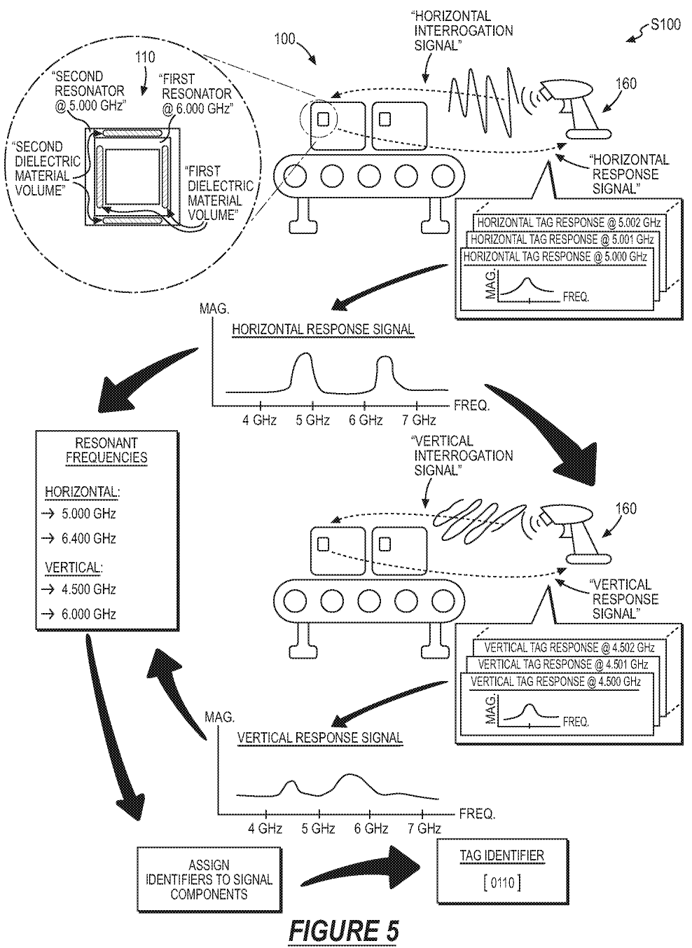

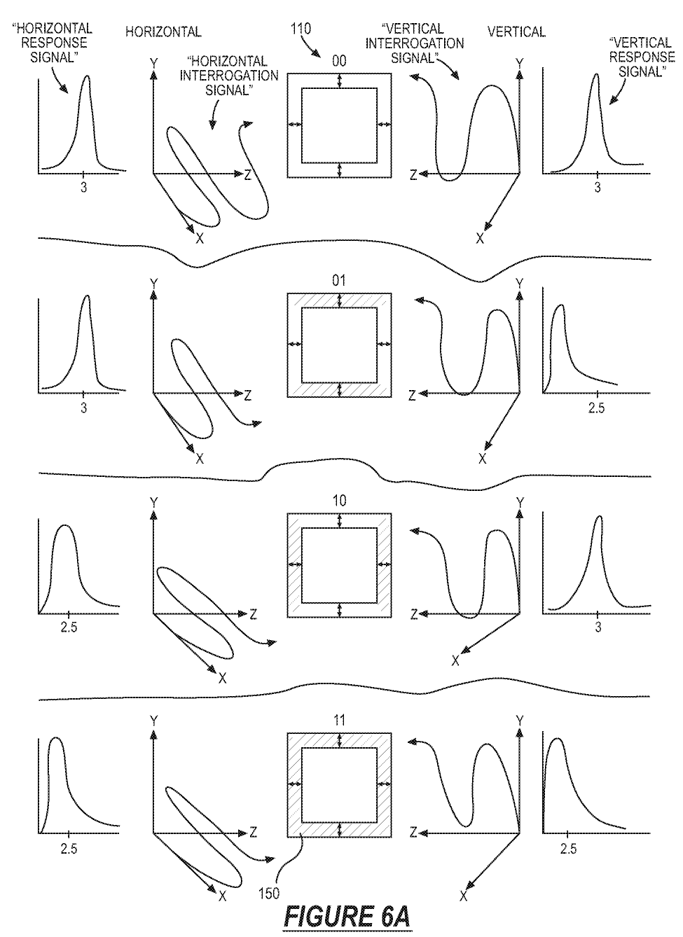

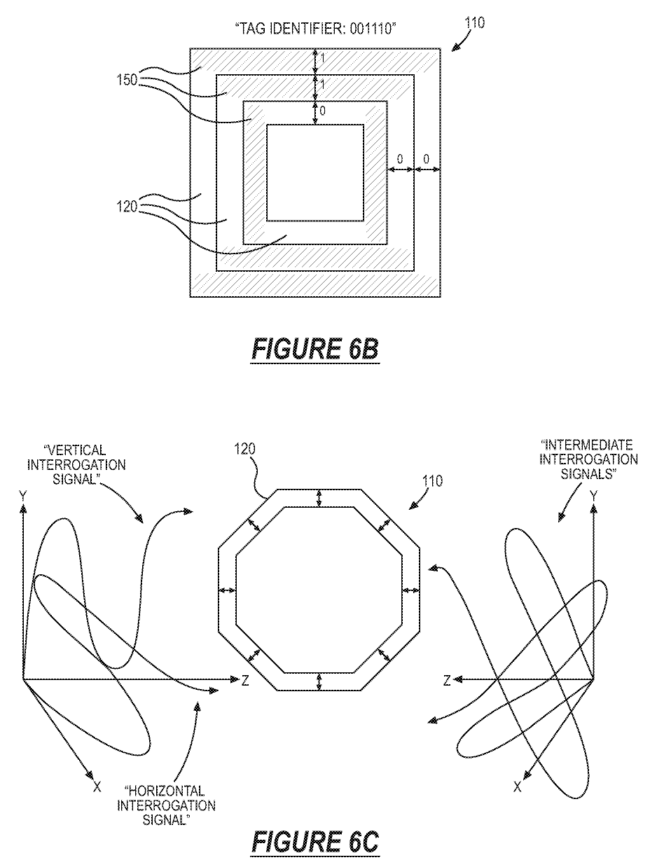

As shown in FIGS. 5, 6A, and 6B, one variation of an identification tag management system 100 includes: an identification tag 110; and a detector 160. The identification tag 110 includes: a substrate; a nested set of square (i.e., conductive) traces arranged on the substrate; and a set of volumes of material 150 arranged on the substrate. The nested set of square traces includes: a first square trace; and a second square trace encompassing and outwardly offset from the first square trace. The second square trace cooperates with the first square trace to form a first square resonator. The nested set of square traces also includes a third square trace: encompassing and outwardly offset from the second square trace; and cooperating with the second square trace to form a second square resonator.

The set of volumes of material 150 includes a first volume of material 150: arranged on the substrate proximal horizontal legs of the first square resonator; and configured to shift a first vertical resonant frequency of the first square resonator. The set of volumes of material 150 also includes a second volume of material 150: arranged on the substrate proximal vertical legs of the first square resonator; and configured to shift a first horizontal resonant frequency of the first square resonator. The set of volumes of material 150 further includes a third volume of material 150: arranged on the substrate proximal horizontal legs of the second square resonator; and configured to shift a second vertical resonant frequency of the second square resonator. The set of volumes of material 150 also includes a fourth volume of material 150: arranged on the substrate proximal vertical legs of the second square resonator; and configured to shift a second horizontal resonant frequency of the second square resonator.

The detector 160 includes: a transmitter; a receiver; and a controller. The transmitter is configured to: broadcast a horizontally-polarized interrogation signal over a band of interrogation frequencies in a horizontal orientation, the band of interrogation frequencies including the first horizontal resonant frequency and the second horizontal resonant frequency; and broadcast a vertically-polarized interrogation signal over a band of interrogation frequencies in a vertical orientation, the band of interrogation frequencies including the first vertical resonant frequency and the second vertical resonant frequency.

The receiver is configured to: receive a horizontally-polarized response signal, broadcast (i.e., passively reflected) by the identification tag 110, over the band of interrogation frequencies responsive to broadcast of the horizontally-polarized interrogation signal by the transmitter; and receive a vertically-polarized response signal, broadcast (i.e., passively reflected) by the identification tag 110, over the band of interrogation frequencies responsive to broadcast of the vertically-polarized interrogation signal by the transmitter. The controller is configured to: detect the first horizontal resonant frequency and the second horizontal resonant frequency in the horizontally-polarized response signal; and detect the first vertical resonant frequency and the second vertical resonant frequency in the vertically-polarized response signal. The controller is further configured to interpret an identifier of the identification tag 110 based on: the first horizontal resonant frequency; the second horizontal resonant frequency; the first vertical resonant frequency; and the second vertical resonant frequency.

### 9. Method

As shown in FIGS. 1-5, a method S100 includes: broadcasting a horizontally-polarized interrogation signal over a band of interrogation frequencies in a horizontal orientation; broadcasting a vertically-polarized interrogation signal over a band of interrogation frequencies in a vertical orientation; receiving a horizontally-polarized response signal, broadcast (i.e., passively reflected) by an identification tag 110, over the band of interrogation frequencies responsive to broadcast of the horizontally-polarized interrogation signal by the transmitter; receiving a vertically-polarized response signal, broadcast by the identification tag 110, over the band of interrogation frequencies responsive to broadcast of the vertically-polarized interrogation signal by the transmitter; detecting a horizontal resonant frequency in the horizontally-polarized response signal; interpreting a first identifier corresponding to the horizontal resonant frequency; detecting a vertical resonant frequency in the vertically-polarized response signal; interpreting a second identifier corresponding to the vertical resonant frequency; initializing a tag identifier associated with the identification tag 110; and appending the first identifier and the second identifier to the tag identifier.

### 10. Applications

Generally, the identification tag 110 and the detector 160 cooperate to form an identification tag management system 100. The identification tag 110: includes passive nested radio frequency resonators and volumes of dielectric material that encode a (unique) identifier; and may be adhered onto or integrated into an object (e.g., packaging, a tray, a barrel, a product). The detector 160: broadcasts radio frequency signals that excite – and thus energize – the passive nested radio frequency resonators in the identification tag 110, which broadcast or passively reflect response signals; receives these response signals into the (unique) identifier; and interprets the (unique) identifier of the identification tag 110 from these response signals.

In particular, the identification tag 110: is configured for placement on an object (e.g., a pallet, shipping or storage container, an object, or packaging); includes a set of (i.e., one or more) resonators configured to resonate and broadcast a response signal when interrogated with an interrogation signal; and includes a characteristic layer containing volumes of dielectric, conductive, and/or insulative material arranged in targeted locations, geometries, and amounts over the resonators and configured to modify amplitude, frequency, phase, phase delay, and group delay of the response signal returned by the resonators when interrogated with the interrogation signal. The detector 160 is configured: to broadcast interrogation signals (e.g., a series of radio frequency signals) over a band of interrogation frequencies (or “interrogation band”) and at a range of orientations (e.g., vertical and horizontal); to detect and record response signals returned by the identification tag 110 responsive to broadcast of these interrogation signals; to identify signal characteristics (e.g., resonant frequency, amplitude, phase, phase delay, group delay) of these response signals; and to interpret a (pseudo-) unique tag identifier (e.g., a 32-bit identifier) based on the signal characteristics of these response signals.

### 10.3 Circular Resonator

The identification tag 110 can include a set of concentrically-nested, circular resonators (e.g., continuous conductive traces) that define a passive, polarization-sensitive resonator structure. The identification tag 110 can further include a set of (i.e., one or more) volumes of material 150 (e.g., dielectric material), each volume of material 150 arranged over a particular arc segment (e.g., between 60 degrees and 90 degrees) of a circular resonator. In one example, the identification tag 110 includes a set of two volumes of material 150 arranged over a pair of opposing arc segments of a circular resonator (e.g., arranged within a gap between opposing traces, arranged over traces, or a combination thereof), such that a polarized interrogation signal propagating along the axis intersecting the opposing arc segments interacts with both volumes of material 150 to shift a signal characteristic of the response signal. For example, a polarized interrogation signal aligned with the opposing arc segments interacts with both volumes of material 150 to generate a detectable shift in the resonant frequency of the response signal relative to a baseline response of the resonator without the volumes of material 150.

For example, the identification tag 110 can include a first circular resonator exhibiting a first radius. The identification tag 110 can further include: a first volume of material 150 arranged over a first arc segment of the first circular resonator intersecting a vertical axis; and a second volume of material 150 arranged over a second arc segment of the first circular resonator opposite the first arc segment and intersecting the vertical axis. In this example, a first interrogation signal broadcast at a first polarization aligned with the vertical axis excites the first circular resonator, and the first and second volumes of dielectric material cooperate to shift a first target signal characteristic (e.g., a resonant frequency) of the first response signal from a first baseline signal characteristic of the first circular resonator. The detector 160 can then interpret a first identifier value based on a difference between the first target signal characteristic and the first baseline signal characteristic.

In one application, the circular resonator can reduce the sensitivity of the detector 160 to rotational misalignment of the identification tag 110 by increasing the range of rotational orientations across which the detector 160 can accurately read the identification tag 110. In particular, because each arc segment of a circular resonator spans a continuous angular range (e.g., 60 degrees to 90 degrees on each side of an axis), a polarized interrogation signal broadcast by the detector 160 excites the arc segment across the full angular span. More specifically, the detector 160 can accurately read the identification tag 110 across a range of rotational offsets, such that a rotational offset of the identification tag 110 relative to the detector 160 (e.g., due to mounting variation on a conveyor, tray, or packaging) does not prevent the detector 160 from detecting the response signal. Accordingly, the detector 160 can accurately identify the identification tag 110 in environments where the identification tag 110 is not precisely oriented relative to the detector 160, such as on a package traversing a conveyor belt, on a garment exiting a laundry facility, or on a pallet loaded onto a truck.

In one example, the identification tag 110 is arranged on an assembly tote traversing a conveyor in a manufacturing facility. In this example, the detector 160 is mounted adjacent the conveyor in a fixed position and is configured to scan each identification tag 110 as the conveyor traverses the assembly tote past the detector 160. The detector 160: broadcasts interrogation signals at a first polarization and a second polarization over the band of interrogation frequencies; receives response signals from the identification tag 110; and interprets a tag identifier associated with the assembly tote within a predefined interrogation window (e.g., 250 milliseconds). Alternatively, the detector 160 can broadcast a circularly-polarized interrogation signal encompassing a range of polarization orientations and receive response signals at one or more polarizations of interest (e.g., horizontal, vertical, or an intermediate polarization orientation such as 35 degrees) over the band of interrogation frequencies.

In another example, the identification tag 110 is configured for placement on garments (e.g., at a garment cleaning facility). In this example, the identification tag 110 includes a set of circular resonators fabricated on a flexible substrate and configured to withstand environmental conditions, including moisture, temperature variation, mechanical stress, and do not passively cannot radiate thermal heat or emit VIS/NIR (Visible/ Near-Infrared) waves. In particular, in this example, the identification tag 110 may be subjected to environmental contaminants (e.g., moisture, salt water, detergent residue, mechanical compression) and rotational misalignment (e.g., due to garment folding or crumpling). The detector 160 can: mount at a fixed position at an entrance to a warehouse or staging area; or be carried on a vehicle. Each identification tag 110 can encode a tag identifier (e.g., a 28-bit tag identifier) that uniquely identifies a garment that the identification tag 110 is affixed to. In this example, the detector 160 can: interrogate an identification tag 110 traversing past the detector 160; extract signal characteristics from a response signal passively broadcast by the identification tag 110; identify the tag identifier of the identification tag 110 based on these signal characteristics; and transmit the tag identifier to a logistics management system, such as for inventory tracking. In particular, in this example, the circular resonator geometry reduces the sensitivity of the detector 160 to this rotational misalignment, such that the detector 160 can accurately read the identification tag 110 across the range of orientations (e.g., introduced by folding or crumpling of a garment on which the identification tag 110 is located).

### 10.4 Dual-Polarization Interrogation

In one application, the detector 160 is configured to broadcast interrogation signals at multiple polarizations to excite different arc segments of each resonator in the identification tag 110 and thus extract additional identifier values from each resonator. In particular, the detector 160 can broadcast a first interrogation signal at a first polarization (e.g., aligned with a vertical axis) and a second interrogation signal at a second polarization (e.g., aligned with a horizontal axis orthogonal to the first polarization) over a band of interrogation frequencies. The first interrogation signal excites arc segments of the resonator intersecting the vertical axis, and the second interrogation signal excites arc segments of the resonator intersecting the horizontal axis, such that the detector 160 can extract two independent sets of signal characteristics from a single resonator. The detector 160 can then interpret two independent identifier values from a single resonator: a first identifier value based on signal characteristics of a first response signal received responsive to the first interrogation signal; and a second identifier value based on signal characteristics of a second response signal received responsive to the second interrogation signal.

Accordingly, the identification tag 110 can store an increased quantity of identifier values encoded per resonator, without increasing the physical size of the resonator or the identification tag 110. For example, a single circular resonator interrogated at two orthogonal polarizations can encode two independent identifier values, whereas the same circular resonator interrogated at a single polarization can encode a single identifier value. The detector 160 can then concatenate the first identifier value and the second identifier value into a tag identifier associated with the identification tag 110.

In one variation, the detector 160 can broadcast interrogation signals at three or more polarizations (e.g., at 0 degrees, 60 degrees, and 120 degrees) to excite three or more sets of arc segments of a circular (or polygonal) resonator and thus extract three or more independent identifier values from a single resonator. The detector 160 can then compile the identifier values into a tag identifier.

### 10.5 Square Resonator

The identification tag 110 can include a set of concentrically-nested, square resonators that define a passive, polarization-sensitive resonator structure. More specifically, each square resonator includes a pair of vertical legs configured to broadcast a vertical response when excited by a first interrogation signal (i.e., across the vertical legs) broadcast by the detector 160 at a first incident angle (e.g., +45 to -45°). The identification tag 110 can further include volumes of dielectric material (i.e., the characteristic layer) arranged over the pair of vertical legs and configured to shift a frequency characteristic of the vertical response (e.g., reduce or increase the resonant frequency of the vertical response relative to a nominal or baseline frequency). Additionally, each square resonator includes a pair of horizontal legs configured to broadcast a horizontal response when excited by an interrogation signal (i.e., across the horizontal legs) broadcast by the detector 160 at a second incident angle (e.g., +45 to +135°). More specifically, the identification tag 110 defines a passive electromagnetic structure (i.e., devoid of any active transmission circuitry) that includes resonators configured to reflect polarized interrogation signals.

Furthermore, the identification tag 110 can include volumes of dielectric material (i.e., the characteristic layer) arranged over the pair of horizontal legs and configured to shift a frequency characteristic of the horizontal response (e.g., reduce or increase the resonant frequency of the horizontal response relative to a nominal or baseline value). Accordingly, each square resonator generates two independently detectable response signals (i.e., a horizontal response and a vertical response) based on the geometry and placement of the volumes of material 150. The detector 160 can then identify and associate these signal characteristics with the corresponding resonator and orientation and transform each characteristic into one or more components of the tag identifier.

More specifically, the detector 160 can: broadcast a horizontally-polarized interrogation signal at a first incident angle; detect and record a horizontally-polarized response signal broadcast by the tag responsive to broadcast of the horizontally-polarized interrogation signal; interpret a first set of identifier components based on unique signal properties of the horizontally-polarized response signal; broadcast a vertically-polarized interrogation signal at a second incident angle different from the first incident angle; detect and record a vertically-polarized response signal broadcast by the tag responsive to broadcast of the vertically-polarized interrogation signal; and interpret a second set of identifier components based on unique signal properties of the vertically-polarized response signal. The detector 160 can then aggregate the first and second sets of identifier components into a tag identifier corresponding to the identification tag 110. Therefore, each pair of legs of the square resonator can return a unique, independent polarized response signal responsive to a polarized interrogation signal broadcast by the detector 160, such that the detector 160 can detect two distinct sets of signal characteristics corresponding to a particular square resonator.

Additionally or alternatively, the detector 160 can interrogate the identification tag 110 with elliptical or circular polarization modes. In particular, the detector 160 can implement circular or elliptical interrogation modes to extract redundant or supplementary signal characteristics (e.g., additional frequency peaks) from the tag response, such as based on the configuration of the resonators and the identification tag 110 resolution. Accordingly, the tag architecture and interrogation scheme can be configured to increase tag density, signal fidelity, or compatibility with circular or non-orthogonal polarization patterns.

### 10.6 Polygonal Resonator

In one variation, the identification tag 110 includes a set of concentrically-nested, polygonal resonators with an increased number of sides and leg orientations (e.g., hexagonal, octagonal, or dodecagonal). In particular, each polygonal resonator includes multiple pairs of substantially parallel legs, each pair corresponding to a distinct field-coupling axis aligned with a specific incident angle of an interrogation signal broadcast by the detector 160. Alternatively, the identification tag 110 can include a set of concentrically-nested, circular resonators, wherein each angular segment (e.g., each 1° increment) of the circular resonator corresponds to a distinct dielectric placement region. In this variation, each discrete dielectric volume defines a coupling site that can be excited by a corresponding angular field component of the interrogation signal, such that the detector 160 can resolve frequency shifts by angular segment rather than by leg orientation.

The detector 160 is configured to broadcast interrogation signals over a predefined set of incident angles, where each incident angle in the set of incident angles corresponds to a particular leg pair of the polygonal resonator. Responsive to broadcast of these interrogation signals, each polygonal resonator broadcasts a set of independently polarized response signals, each associated with a particular pair of legs. Additionally, the identification tag 110 can include volumes of dielectric material arranged proximal one or more leg pairs of each polygonal resonator to uniquely modify signal characteristics of the corresponding response signal.

Therefore, each pair of parallel legs in a polygonal resonator defines a separate resonance cavity, such that increasing the quantity of leg pairs increases the quantity of independently detectable response signals. Thus, a higher-order polygonal geometry (e.g., octagonal or dodecagonal) can encode additional bits per resonator, without increasing the physical size of the resonator or tag, by increasing field orientations and distinguishable responses within a single identification tag 110. Additionally, by nesting multiple polygonal resonators concentrically, the identification tag 110 can further increase the quantity of bits encoded within the same identification tag 110 footprint by increasing the quantity of polarization-specific response domains. The detector 160 can then interpret a greater quantity of signal characteristics within the same tag footprint. Accordingly, a polygonal resonator increases the bit density per resonator, and nested polygonal resonators increase the bit density per unit area.

### 10.7 Tuned Resonator Response

The characteristic layer can include one or more volumes of one or more materials that cooperate to shift characteristics of the signal response of the identification tag 110 in predictable modes. In particular, the characteristic layer (i.e., pattern, material, volume, location geometry) can include volumes of material 150 that – individually and/or in combination – predictably modify characteristics (e.g., frequency, amplitude, phase, phase delay, group delay) of a response signal returned by the square resonator when interrogated by the detector 160. More specifically, each volume of material 150 can shift the horizontal or vertically-polarized response signal (or the circular or elliptical response signal) of a particular square resonator (i.e., without affecting the orthogonal axis). The detector 160 can then transform the shift in these characteristics, such as from nominal or known characteristics of the resonators, into components of a (pseudo-) unique tag identifier (e.g., a 28-bit or 64-bit binary string or value).

For example, the characteristic layer can include a first volume of material 150 arranged proximal to the horizontal legs of a square resonator, such that the vertical resonant frequency of the resonator is reduced by 0.001 gigahertz (or “GHz”) from a nominal frequency. More specifically, the identification tag 110 returns a vertically-polarized response signal of peak amplitude when interrogated with a horizontally-polarized interrogation signal at 0.001 GHz less than the nominal vertical frequency of the square resonator. The detector 160 can then interpret a first component of a unique tag identifier of the identification tag 110 based on (e.g., proportional to) this shift in vertical resonant frequency.

### 10.8 Passive Identification Tag without Integrated Circuit

Thus, the identification tag 110 can store a readable (pseudo-) unique tag identifier within a radio-frequency resonator and volumes (or “dots”) of dielectric rather than in integrated circuits or other discrete (e.g., surface-mount) chips, capacitors, inductors, or resistors. In particular, the identification tag 110 can include volumes of material 150 containing common materials, such as epoxy-based mixtures or matrices including metal oxides, high-permittivity dielectrics, or conductive inks, such as barium titanate (BTO), titanium dioxide, or carbon-based conductors. The identification tag 110 can thus exclude rare and exotic materials found in integrated circuits, such as tantalum and cobalt. Accordingly, the identification tag 110 can be disposed of, such as with a pallet or material packaging, without loss of exotic materials to a waste stream and without pressure to recycle such exotic materials. Therefore, the identification tag 110 can be fully disposable with (much) less negative impact on the environment.

### 10.9 Resonator Types + Signal Characteristics

The identification tag 110 is described herein as including concentrically-nested, square resonators. However, the identification tag 110 can include any quantity of concentrically-nested polygonal resonators and/or independently-arranged polygonal resonators that are uniquely modified (i.e., exhibit modified resonant frequencies and other characteristic responses) by the characteristic layer. Additionally or alternatively, the identification tag 110 can include resonators of any other type or geometry (e.g., E-shaped, circular, hexagonal), thus expanding the possible characteristic layer patterns (and unique tag identifiers).

The detector 160 is described herein as detecting a resonant frequency in the horizontally-polarized response signal and/or the vertically-polarized response signal broadcast by the identification tag 110 and interpreting an identifier corresponding to the resonant frequency. However, the detector 160 can interpret identifiers corresponding to other characteristics of the response band broadcast by the identification tag 110, such as: a profile or shape of the response band; and/or a characteristic frequency.

### 11. Terms

A "horizontally-polarized response signal" is referred to herein as a passive radio-frequency response signal broadcast by the identification tag 110 in a first polarization orientation (e.g., horizontal) responsive to excitation by a horizontally-polarized interrogation signal.

A "vertically-polarized response signal" is referred to herein as a passive radio-frequency response signal broadcast by the identification tag 110 in a second polarization orientation (e.g., vertical), non-parallel to the first polarization orientation, responsive to excitation by a vertically-polarized interrogation signal.

A "horizontally-polarized interrogation signal" is referred to herein as a radio-frequency interrogation signal broadcast by the detector 160 in a first polarization orientation (e.g., horizontal) and configured to excite arc segments of the identification tag 110 intersecting a vertical axis.

A "vertically-polarized interrogation signal" is referred to herein as a radio-frequency interrogation signal broadcast by the detector 160 in a second polarization orientation (e.g., vertical), non-parallel to the first polarization orientation, and configured to excite arc segments of the identification tag 110 intersecting a horizontal axis.

A “first square trace” is referred to herein as an innermost trace (i.e., a conductive path) arranged on the substrate and defining an inner boundary of an innermost resonator.

A “second square trace” is referred to herein as a second innermost square trace encompassing and outwardly offset from the first square trace. In particular, the first square trace is nested concentrically about the second square trace. Thus, the second square trace defines an outer boundary of the innermost resonator, and an inner boundary of a second innermost resonator.

A “third square trace” is referred to herein as a third innermost square trace encompassing and outwardly offset from the second square trace. In particular, the first and second square traces are nested concentrically about the third square trace. Thus, the third square trace defines an outer boundary of the second innermost resonator.

A “resonator” is referred to herein as a passive radio-frequency structure configured to resonate and emit a response signal when interrogated with a radio-frequency interrogation signal at or near a resonant frequency of the resonator. Each resonator includes: a pair of concentric square traces, including an inner trace and an outer trace; and a gap region extending between the inner and outer traces. Each resonator defines: a pair of horizontal legs including an upper horizontal leg and a lower horizontal leg configured to couple with the electric field of a vertically-polarized interrogation signal; and a pair of vertical legs including a left vertical leg and a right vertical leg configured to couple with the electric field of a horizontally-polarized interrogation signal. Each resonator can resonate across the gap region between the inner and outer traces and broadcast a response signal when excited by an interrogation signal with a polarization aligned with the field-coupling axis of one of pairs of legs of the resonator. An identification tag 110 can include a set of nested square (or rectilinear) resonators arranged on the substrate. In particular, a “first target resonator 120” is referred to herein as an innermost resonator defined between the first (i.e., innermost) square trace and the second (i.e., second innermost) square trace that encompasses the first square trace. Additionally, a “second target resonator 120” is referred to herein as a second innermost resonator defined between the second (i.e., second innermost) square trace and the third (i.e., third innermost) square trace that encompasses the second square trace.

### 12. Example: Identification Tag with Three Resonators

In one example, an identification tag 110 is arranged on a manufacturing tote, located in a manufacturing facility, configured to store and transport subcomponents during an assembly process. In this example, the identification tag 110 includes a set of three nested square resonators arranged on a substrate. In particular, the set of resonators includes: a first (i.e., innermost) resonator tuned to an initial resonant frequency of 5.000 GHz; a second (i.e., second innermost) resonator outwardly offset from (i.e., encompassing) the first target resonator 120 and tuned to an initial resonant frequency of 4.000 GHz; and a third (i.e., outermost) resonator outwardly offset from (i.e., encompassing) the second target resonator 120 and tuned to an initial resonant frequency of 3.000 GHz. The identification tag 110 further includes: a first volume of material 150 arranged over vertical legs of the first target resonator 120 and configured to shift a first horizontal resonant frequency of the first target resonator 120 from 5.000 GHz to 4.500 GHz; a second volume of material 150 arranged over horizontal legs of the second target resonator 120 and configured to shift a second vertical resonant frequency of the second target resonator 120 from 4.000 GHz to 3.500 GHz; and a third volume of material 150 arranged over horizontal legs of the third resonator and configured to shift a third vertical resonant frequency of the third resonator from 3.000 GHz to 2.500 GHz.

In this example, a detector 160 is arranged on a conveyor (e.g., within an assembly line) located in the manufacturing facility and configured to scan identification tags 110 on each manufacturing tote as the conveyor traverses the manufacturing tote past the detector 160 (e.g., during stage-to-stage transfer of partially-assembled products). In particular, as the conveyor traverses the manufacturing tote past the detector 160, the detector 160: broadcasts a series of horizontally-polarized interrogation signals over an interrogation band between 2.000 GHz to 6.000 GHz (e.g., in 0.001 GHz increments) in a horizontal orientation; broadcasts a series of vertically-polarized interrogation signals over the interrogation band in a vertical orientation; and records a series of response signals (or a “response band”) broadcast by the identification tag 110 as a result of the interrogation signals energizing the set of resonators. In particular, based on the response band, the detector 160 can then detect: a first horizontal resonant frequency at 3.000 GHz (i.e., the “unshifted” horizontal frequency of the third resonator); a second horizontal resonant frequency at 4.000 GHz (i.e., the “unshifted” horizontal frequency of the second target resonator 120); a third horizontal resonant frequency at 4.500 GHz (i.e., the “shifted” horizontal frequency of the first target resonator 120); a first vertical resonant frequency at 2.500 GHz (i.e., the “shifted” vertical frequency of the third resonator); a second vertical resonant frequency at 3.500 GHz (i.e., the “shifted” vertical frequency of the second target resonator 120); and a third vertical resonant frequency at 5.000 GHz (i.e., the “unshifted” vertical frequency of the first target resonator 120).

The detector 160 then assigns a binary identifier to each resonant frequency based on presence or absence of a frequency shift in the resonant frequency (i.e., a binary value of “0” for unshifted resonant frequencies or a binary value of “1” for shifted resonant frequencies). For example, the detector 160 assigns a binary identifier of “1” to the horizontal resonant frequency detected at 4.500 GHz (i.e., the “shifted” horizontal frequency of the first target resonator 120).

The detector 160 then concatenates each binary identifier into a tag identifier associated with the identification tag 110. In particular, in this example, the detector 160 assembles the tag identifier according to a predefined schema, such as in the following order: horizontal resonant frequencies, ordered from the outermost resonator to the innermost resonator (i.e., third, second, first target resonators 120); and vertical resonant frequencies, ordered from the outermost resonator to the innermost resonator. Thus, in this example, the detector 160 converts resonant frequency shifts (i.e., resulting from placement of volumes of material 150) into a six-bit tag identifier of “001110.” This identifier can then be linked to the specific manufacturing tote, such as for routing, sorting, or tracking the manufacturing tote throughout the assembly facility.

### 13. Identification Tag

Generally, the identification tag 110 is configured to (transiently) locate on an object, such as a pallet, a shipping or storage container (e.g., an assembly tote), an object, or packaging. The identification tag 110 stores a tag identifier in the form of: a resonator that resonates and broadcasts (i.e., passively reflects) a radio-frequency response when energized by a radio-frequency interrogation signal; and a characteristic layer that contains one or more dielectrics in controlled volumes, locations, and geometries, which modify the radio-frequency response (e.g., resonator frequency, resonance amplitude or attenuation, phase, phase delay, group delay) of the resonator when interrogated by radio-frequency interrogation signals over the interrogation band.

The identification tag 110 includes: a substrate; a set of (i.e., one or more) resonators; and the characteristic layer arranged over the substrate and the set of resonators. For example, the substrate can include a flexible backing (e.g., a paper, fiberglass, or polyimide) forming a base for the set of resonators; and an adhesive backing configured to transiently adhere the identification tag 110 to the object. In one variation, the identification tag 110 further includes a cover layer enclosing the set of resonators and the characteristic layer over the substrate.

The set of resonators (i.e., forming an equivalent RLC circuit) can be configured to broadcast (i.e., passively reflect) the response signal. Each resonator can be at least partially formed from a conductive material (e.g., silver, gold, platinum, aluminum, copper, tin). For example, each resonator can: define a square (or rectilinear) shape; and include a pair of horizontal legs and a pair of vertical legs. The set of resonators can be configured to broadcast a unique set of signal properties, such that a response signal broadcast by the identification tag 110 includes a quantity of unique sets of signal properties (e.g., unique resonant frequencies) corresponding to the quantity of resonators. In one example, the identification tag 110 includes a set of ten concentrically-nested, square resonators, such that the response signal broadcast by the identification tag 110 includes ten resonant frequencies.

The characteristic layer can be configured to shift the resonant frequency of the set of resonators to broadcast a unique identification response signal for identifying a particular identification tag 110. In particular, the features of the characteristic layer (i.e., pattern, material, volume, and/or polarization) are selected to broadcast a response signal defined by a set of unique signal characteristics (i.e., frequency, amplitude, phase, phase delay, and/or group delay). More specifically, the characteristic layer includes a set of volumes of material 150 (i.e., one or more) arranged on the set of resonators in a pattern. For example, the pattern can be defined by: a quantity of discrete volumes of material 150 (or “discrete volumes); a shape of each discrete volume (e.g., a dot-shaped volume, a line-shaped volume); and a position of each discrete volume.

The characteristic layer can include discrete volumes of material 150, each formed from a material (e.g., a dielectric material, a conductive material, an insulative material and/or a combination thereof), such as a polymer-based material, a resin-based material, or any other dielectric, conductive, or insulative material and/or a combination thereof (i.e., a hybrid material). For example, the material can be polyethylene terephthalate (PET), high-density polyethylene (HDPE), carbon black, titanium dioxide, an epoxy-based material including trace elements (e.g., carbon, ceramic, metallic, ferrous), a porous polymer, a PTFE-based composite, and/or pure copper.

Furthermore, the characteristic layer can include discrete volumes of material 150, wherein each volume includes a single material or a hybrid combination of materials. Furthermore, the characteristic layer can include discrete volumes of material 150, where each volume can include the same material or a different material than the adjacent volumes.

In particular, the identification tag 110 encodes a tag identifier within differences between baseline signal characteristics of the set of resonators and target signal characteristics of the set of resonators, these differences resulting from placement of volumes of material 150 over the set of resonators. In particular, each resonator exhibits a set of baseline signal characteristics (e.g., a baseline resonant frequency, a baseline amplitude, a baseline phase, a baseline group delay) when devoid of dielectric material. The characteristic layer modifies one or more baseline signal characteristics of the resonator such that, when excited by an interrogation signal, the identification tag 110 passively broadcasts a target response signal exhibiting a set of target signal characteristics (e.g., a shifted resonant frequency, a modified amplitude, a modified phase). More specifically, the volumes of material 150 modify the real and imaginary components of the response signal returned by each resonator. Each scalar signal characteristic derived from the response signal — such as resonant frequency, amplitude, phase, group delay, or equivalent circuit parameter (e.g., resistance, inductance, capacitance) — corresponds to a function of these real and imaginary components. Accordingly, the detector 160 can derive any such scalar signal characteristic from the real and imaginary components of the response signal to identify the identification tag 110.

For example, a first volume of material 150 arranged proximal a first arc segment of a first target resonator 120 can shift a first target signal characteristic (e.g., a resonant frequency of 5.625) from a first baseline signal characteristic (e.g., a baseline resonant frequency of 5.000 gigahertz) by a first difference (e.g., a shift of 0.500 gigahertz to a target resonant frequency of 4.500 gigahertz). The detector 160 can then implement methods and techniques described below to interpret a first identifier value based on the first difference, such as a binary value (e.g., “1” for presence of a shift, “0” for absence of a shift) or a multi-bit value proportional to an amplitude of the first difference.

Accordingly, the identification tag 110 can encode a tag identifier (e.g., 6 bits, 12 bits, 28 bits, 64 bits, 128 bits) corresponding to: a quantity of resonators in the identification tag 110; a quantity of interrogation polarizations; and a quantity and placement of volumes of material 150 in the characteristic layer. The detector 160 can then reconstruct the tag identifier by detecting and interpreting signal characteristic shifts across the set of resonators at each interrogation polarization.

### 13.3 Tag Enclosure

In one variation, the identification tag 110 is encapsulated within a protective tag enclosure configured to surround and mechanically isolate the identification tag 110 within a chemically resistant structure. In one example, the tag enclosure includes: a base defining a recessed cavity configured to house the resonant and characteristic layers; and an upper layer configured to couple to the base to encapsulate the resonant and characteristic layers without contacting or compressing the characteristic layer. In particular, the upper layer is offset above the resonant and characteristic layers to prevent mechanical contact with the volumes of material 150, thereby preserving dielectric geometry and avoiding unintended changes in effective permittivity (e.g., due to compression or interface effects). Therefore, the tag enclosure maintains dielectric fidelity and response consistency during operation, such as in chemically aggressive or mechanically dynamic environments.

### 14. Detector

The detector 160 includes: a transmitter configured to broadcast interrogation signals over a frequency band at one or more polarizations; a receiver configured to receive the response signals passively broadcast by the identification tag 110; and a controller. For example, the transmitter can broadcast a set of interrogation signals characterized by incremental frequency steps spanning the frequency band (e.g., 2.000 GHz to 5.000 GHz in 0.001 GHz steps). The receiver can then record inbound signals at each detection frequency and store these inbound signals as a response signal.

In one variation, the transmitter includes a dual-polarized antenna configured to broadcast interrogation signals at a first polarization (e.g., aligned with a vertical axis) and at a second polarization (e.g., aligned with a horizontal axis orthogonal to the first polarization). The dual-polarized antenna can include: a first antenna element configured to broadcast interrogation signals at the first polarization; and a second antenna element configured to broadcast interrogation signals at the second polarization. In one implementation, the dual-polarized antenna includes a patch antenna with orthogonal feed points, such that the first antenna element and the second antenna element share a common radiating structure.

In one variation, the transmitter can be configured to broadcast interrogation signals over different portions of the band of interrogation frequencies at corresponding polarizations. For example, the transmitter can concurrently: interrogate a lower portion of the band of interrogation frequencies (e.g., 2.000 gigahertz to 4.500 gigahertz) at a first polarization; interrogate an upper portion of the band of interrogation frequencies (e.g., 4.500 gigahertz to 7.000 gigahertz) at the first polarization; interrogate the lower portion of the band of interrogation frequencies at a second polarization; and interrogate the upper portion of the band of interrogation frequencies at the second polarization. In this variation, the detector 160 can reduce a total interrogation time of the identification tag 110 (e.g., from two seconds to 250 milliseconds) such that the detector 160 can scan identification tags 110 on objects traversing past the detector 160 (e.g., on a conveyor) at a relatively high speed without missing identification tags 110.

The controller is configured to: access the set of response signals recorded by the receiver; identify one or more target response signals corresponding to target resonators 120 based on known baseline resonator characteristics and/or signal power thresholds; and detect a set of target radio frequency signal characteristics in each target response signal. In particular, the set of target radio frequency signal characteristics can include: a target resonant frequency; an amplitude at the target resonant frequency; a phase offset at the target resonant frequency; a phase delay; and/or a group delay. For example, the controller can derive these target radio frequency signal characteristics via signal processing operations, such as Fourier transform analysis, phase demodulation, and/or peak tracking over the response band.

For each target signal characteristic, the controller is further configured to interpret an identifier component corresponding to the target signal characteristic. In one implementation, the controller can: calculate a difference between the target signal characteristic and a baseline signal characteristic associated with the corresponding target resonator 120; and transform this difference into a binary value representing an identifier component. The controller can then aggregate multiple identifier components into a tag identifier of the identification tag 110. For example, the controller can: transform a 0.005 GHz shift in resonant frequency into a 12-bit binary value representing a location code; and transform a 20% amplitude attenuation into an 8-bit binary value representing an expiration status. The controller can then assemble these values into a composite tag identifier corresponding to the object on which the identification tag 110 is arranged.

Additionally or alternatively, the controller can access a tag database mapping known signal characteristics to previously-stored tag identifiers. In this variation, the controller can: query the tag database based on the set of detected target signal characteristics; and identify the tag identifier of the identification tag 110 based on a match or nearest-neighbor correlation to stored signal profiles. Thus, the detector 160 can identify the presence and identity of the identification tag 110 by interpreting signal characteristics of the target response signal, without requiring integrated electronics or active signaling from the identification tag 110.

Furthermore, the detector 160 can be configured for fixed-position installation (e.g., mounted adjacent a conveyor belt, at a doorway, on a shelf) or for portable operation (e.g., mounted on a vehicle, carried by a user). In one variation, the detector 160 can execute an interrogation cycle with a fixed interrogation position and a stepped interrogation frequency. For example, the detector 160 can include: an ellipsoidal antenna configured to broadcast a wide polarization profile from a fixed point; an articulating antenna configured to maintain a fixed position while adjusting polarization over time; or a solid-state phased array configured to control an angular phase profile of broadcast signals electronically without physical movement.

### 15. Identification Tag with Single Square Resonator

In one implementation, as shown in FIGS. 5, 6A, and 6B, the identification tag 110 can include a single, square resonator arranged on the substrate. In particular, the identification tag 110 can include: a first square trace arranged on the substrate; and a second square trace arranged on the substrate and encompassing the first square trace. More specifically, the second square trace: is outwardly offset from the first square trace; and cooperates with the first square trace to form a square resonator. The identification tag 110 can further include volumes of material 150 arranged over the pair of horizontal legs and/or the pair of vertical legs to uniquely modify signal characteristics of the corresponding response signal.

### 15.3 Reading Single Square-resonator Identification Tags: Binary States

Generally, the detector 160 can: broadcast a horizontally-polarized interrogation signal over a band of interrogation frequencies (or “interrogation band”) in a horizontal orientation; receive a horizontally-polarized response signal, broadcast by an identification tag 110, over the interrogation band responsive to broadcast of the horizontally-polarized interrogation signal; broadcast a vertically-polarized interrogation signal over the interrogation band in a vertical orientation; receive a vertically-polarized response signal, broadcast by the identification tag 110, over the interrogation band responsive to broadcast of the vertically-polarized interrogation signal; and derive a tag identifier of the identification tag 110 based on signal characteristics of the horizontal and vertically-polarized response signals.

In one implementation, the detector 160 can: detect peak frequencies of each response signal; and assign binary identifiers to each peak frequency in the response signal based on presence or absence of a frequency shift (i.e., relative to the initial resonant frequency) in the response signal (i.e., a binary value of “0” for unshifted resonant frequencies or a binary value of “1” for shifted resonant frequencies). The detector 160 can then assemble (or “concatenate”) the binary identifiers into a tag identifier associated with the identification tag 110.

In one example, as shown in FIG. 5, an identification tag 110 includes: a square resonator tuned to an initial resonant frequency of 3.000 GHz; and a volume of material 150 arranged on the substrate proximal horizontal legs of the square resonator and configured to shift a vertical resonant frequency of the square resonator to 3.100 GHz. In this example, the detector 160 interrogates the identification tag 110 (i.e., broadcasts interrogation signals) over an interrogation band between 2.800 GHz and 3.200 GHz (e.g., in 0.001 GHz increments). The detector 160 then: detects a horizontal resonant frequency, corresponding to the identification tag 110, at 3.000 GHz in the horizontally-polarized response signal; and assigns a first binary identifier of “0” to the horizontally-polarized response signal in response to detecting the horizontally-polarized response signal matching the initial resonant frequency of 3.000 GHz. Additionally, the detector 160: detects a vertical resonant frequency, corresponding to the identification tag 110, at 3.100 GHz in the vertically-polarized response signal; and assigns a second binary identifier of “1” to the vertically-polarized response signal in response to detecting a difference between the vertically-polarized response signal and the initial resonant frequency of 3.000 GHz. Thus, in this example, the detector 160 interprets a tag identifier of “01” associated with the identification tag 110.

### 15.4 Reading Single Square-resonator Identification Tags: High-Encoding States

In one implementation, the detector 160 can: detect a peak frequency of each response signal; identify a frequency subrange, in the interrogation band, corresponding to the peak frequency; initialize a tag identifier for the identification tag 110; and append the tag identifier with a frequency identifier corresponding to the frequency subrange.

For example, in the preceding example, the detector 160 can: detect a horizontal resonant frequency, corresponding to the identification tag 110, at 3.000 GHz in the horizontally-polarized response signal; identify a first frequency subrange, such as between 2.975 GHz and 3.025 GHz, corresponding to the horizontal resonant frequency; and append the tag identifier with a first frequency identifier representing the first frequency subrange (e.g., a numerical value of 511) in 12-bit binary format (e.g., “000011111111”). In particular, in this example, the interrogation band can include a set of frequency subranges spanning from the lower boundary to the upper boundary of the interrogation band, each frequency subrange corresponding to an encoded numerical value (i.e., the frequency identifier). Furthermore, the detector 160 can repeat this process to: detect the vertical resonant frequency (i.e., at 3.100 GHz); and append the tag identifier with a second frequency identifier representing a second frequency subrange, such as a numerical value of 525 corresponding to the second frequency subrange between 3.075 GHz and 3.125 GHz, in 12-bit binary format (e.g., “000100001101”).

Additionally, the detector 160 can then repeat this process for each signal characteristic (i.e., amplitude, phase shift, phase delay, and group delay) and append corresponding identifiers to the tag identifier. For example, each signal characteristic can encode in a defined density (e.g., 12-bit, 16-bit). Alternatively, the tag identifier can be represented in another format, such as a 28-bit binary string, a 64-bit binary string, and/or a 128-bit binary string. Therefore, the identification tag management system 100 can identify signal characteristics (e.g., peak frequency), encode each signal characteristic into an identifier, and assemble comprehensive sets of identifiers.

### 16. Identification Tag with Multiple Square Resonators

In one implementation, the identification tag 110 can include a set of (i.e., two or more) concentrically-nested, square resonators. For example, the identification tag 110 can include: a first square trace arranged on the substrate; a second square trace arranged on the substrate and encompassing the first square trace; and a third square trace arranged on the substrate and encompassing the second square trace. In particular, the second square trace: is outwardly offset from the first square trace; and cooperates with the first square trace to form a first square resonator. Additionally, the third square trace: is outwardly offset from the second square trace; and cooperates with the second square trace to form a second square resonator.

### 16.3 Reading Multi-square-resonator Identification Tags

In one implementation, the detector 160 can implement methods and techniques described above to interpret an identifier of an identification tag 110 including a set of square resonators. In one example, as shown in FIG. 5, an identification tag 110 includes: a first square resonator tuned to an initial resonant frequency of 6.000 GHz; a second square resonator (i.e., encompassing the first square resonator) tuned to an initial resonant frequency of 5.000 GHz; a first volume of material 150 arranged on the substrate proximal vertical legs of the first square resonator and configured to shift a horizontal resonant frequency of the first square resonator to 6.400 GHz; and a second volume of material 150 arranged on the substrate proximal horizontal legs of the second square resonator and configured to shift a second vertical resonant frequency of the second square resonator to 4.500 GHz.

In this example, the detector 160: interrogates the identification tag 110 (i.e., broadcasts interrogation signals) over an interrogation band between 4.000 GHz and 7.000 GHz (e.g., in 0.001 GHz increments); detects a first horizontal resonant frequency at 5.000 GHz and a second horizontal resonant frequency at 6.400 GHz in the horizontally-polarized response signal; and detects a first vertical resonant frequency at 4.500 GHz and a second vertical resonant frequency at 6.000 GHz in the vertically-polarized response signal. The detector 160 can then implement methods and techniques described above to: assign a first binary identifier of “0” to the first horizontally-polarized response signal (i.e., matching the initial resonant frequency); assign a second binary identifier of “1” to the second horizontally-polarized response signal (i.e., divergent from the initial resonant frequency); assign a third binary identifier of “1” to the first vertically-polarized response signal; assign a fourth binary identifier of “0” to the second vertically-polarized response signal; and assemble a tag identifier of “0110” associated with the identification tag 110.

Alternatively, the detector 160 can then implement methods and techniques described above to: identify frequency subranges corresponding to each peak frequency in the response signals; and append the tag identifier with frequency identifiers representing the frequency subranges. Thus, the detector 160 can interpret shifts in resonant frequency across multiple resonators and polarization modes to accurately generate a multi-bit tag identifier uniquely associated with the identification tag 110.

### 17. Identification Tag with Circular Resonators

In one implementation, as shown in FIG. 1, the identification tag 110 can include a set of (i.e., one or more) concentrically-nested, circular resonators. Alternatively, the identification tag 110 can include a set of concentrically-nested, discontinuous circular resonators (e.g., split ring resonators). For example, the identification tag 110 can include: a first circular resonator arranged on the substrate; a second circular resonator arranged concentrically about (e.g., encompassing) the first circular resonator; and a third circular resonator arranged concentrically about (e.g., encompassing) the second circular resonator. In this example, the second circular resonator is outwardly offset from the first circular resonator, and the third circular resonator is outwardly offset from the second circular resonator. The identification tag 110 can further include volumes of material 150 arranged over arc segments of each circular resonator to independently modify signal characteristics of the corresponding response signal for each circular resonator. For example, the identification tag 110 can include a volume of material 150 arranged over an arc segment spanning between 60 degrees and 90 degrees of the target resonator 120. Accordingly, the identification tag 110 can encode a multi-bit tag identifier by independently shifting signal characteristics of each circular resonator at each polarization.

In one example, the identification tag 110 can include: a first target resonator 120; and a second target resonator 120. In this example, the identification tag 110 can be configured to: broadcast a first target response signal (e.g., a horizontally-polarized response signal) responsive to excitation by a first interrogation signal (e.g., a horizontally-polarized interrogation signal); and broadcast a second target response signal (e.g., a vertically-polarized response signal) responsive to excitation by a second interrogation signal (e.g., a vertically-polarized interrogation signal). In this example, the identification tag 110 can further include: a first volume of material 150 arranged over a first arc segment of the first target resonator 120 intersecting a first axis (e.g., a vertical axis); and a second volume of material 150 arranged over a second arc segment of the first target resonator 120, the second arc segment opposite the first arc segment and intersecting the first axis (e.g., the vertical axis). The first volume of material 150 and the second volume of material 150 cooperate to shift a first target signal characteristic (e.g., a resonant frequency) of a first target response signal (e.g., a horizontally-polarized response signal) from a first baseline signal characteristic of the first target resonator 120.

Additionally, in this example, the identification tag 110 can include: a third volume of material 150 arranged over a third arc segment of the second target resonator 120 intersecting a second axis (e.g., a horizontal axis); and a fourth volume of material 150 arranged over a fourth arc segment of the second target resonator 120 opposite the third arc segment and intersecting the second axis (e.g., the horizontal axis). The third volume of material 150 and the fourth volume of material 150 cooperate to shift a second target signal characteristic of a second target response signal (e.g., a vertically-polarized response signal) of the second target resonator 120 from a second baseline signal characteristic of the circular resonator. Accordingly, the identification tag 110 can encode two independent identifier values: a first identifier value encoded in the first target signal characteristic responsive to a first interrogation signal at a first polarization; and a second identifier value encoded in the second target signal characteristic responsive to a second interrogation signal at a second polarization.

In particular, in this example, the horizontally-polarized response signal can be characterized by a first target signal characteristic, the first target signal characteristic encoding a first identifier value corresponding to a tag identifier of the identification tag 110. Additionally, the vertically-polarized response signal can be characterized by a second target signal characteristic, the second target signal characteristic encoding a second identifier value forming the tag identifier in combination with the first identifier value. In this example, the second volume of material 150 can cooperate with the first volume of material 150 to shift the first target signal characteristic from a first baseline signal characteristic by a first difference that encodes a first identifier value in the first set of identifier values corresponding to the tag identifier.

For example, in the preceding example, a first dimension of the first volume of material 150 and the second volume of material 150 can correspond to a first difference between the first baseline signal characteristic and the first target signal characteristic, the first difference encoding a first identifier value of the tag identifier. Additionally, a third dimension of the third volume of material 150 and the fourth volume of material 150 can correspond to a second difference between the second baseline signal characteristic and the second target signal characteristic, the second difference encoding the second identifier value of the tag identifier.

### 17.3 Reading Circular-resonator Identification Tags

In one implementation, the detector 160 can: broadcast interrogation signals over the band of interrogation frequencies at one or more polarizations; receive target response signals broadcast by the identification tag 110; and derive a tag identifier of the identification tag 110 based on signal characteristics of the target response signals. For example, the detector 160 can implement methods and techniques described above to: detect peak frequencies of each response signal; and assign binary identifiers to each peak frequency in the target response signal based on presence or absence of a frequency shift (i.e., relative to the initial resonant frequency) in the response signal (i.e., a binary value of “0” for unshifted resonant frequencies or a binary value of “1” for shifted resonant frequencies). The detector 160 can then assemble (or “concatenate”) the binary identifiers into a tag identifier associated with the identification tag 110. Alternatively, the detector 160 can implement methods and techniques described above to: detect a peak frequency of each response signal; identify a frequency subrange, in the interrogation band, corresponding to the peak frequency; initialize a tag identifier for the identification tag 110; and append the tag identifier with a frequency identifier corresponding to the frequency subrange.

For example, in the preceding example, the detector 160 can: broadcast a horizontally-polarized interrogation signal aligned with the horizontal axis; broadcast the vertically-polarized interrogation signal aligned with the vertical axis; receive a horizontally-polarized response signal passively broadcast by the identification tag 110 responsive to excitation of the first target resonator 120 and the second target resonator 120 by the horizontally-polarized interrogation signal; and receive a vertically-polarized response signal passively broadcast by the identification tag 110 responsive to excitation of the first target resonator 120 and the second target resonator 120 by the vertically-polarized interrogation signal. The detector 160 can then derive a tag identifier of the identification tag 110 based on: a first set of signal characteristics of the horizontally-polarized response signal; and a second set of signal characteristics of the vertically-polarized response signal.

In particular, the detector 160 can: extract the first set of signal characteristics from the horizontally-polarized response signal; detect the first difference between the first target signal characteristic and the first baseline signal characteristic; and derive the first identifier value of a tag identifier of the identification tag 110 based on the first difference. The detector 160 can then: repeat this process for each signal characteristic in the horizontally-polarized response signal and the vertically-polarized response signal; and aggregate identifier values encoded in each signal characteristic to identify the identification tag 110.

### 17.4 Multi-Axis Encoding

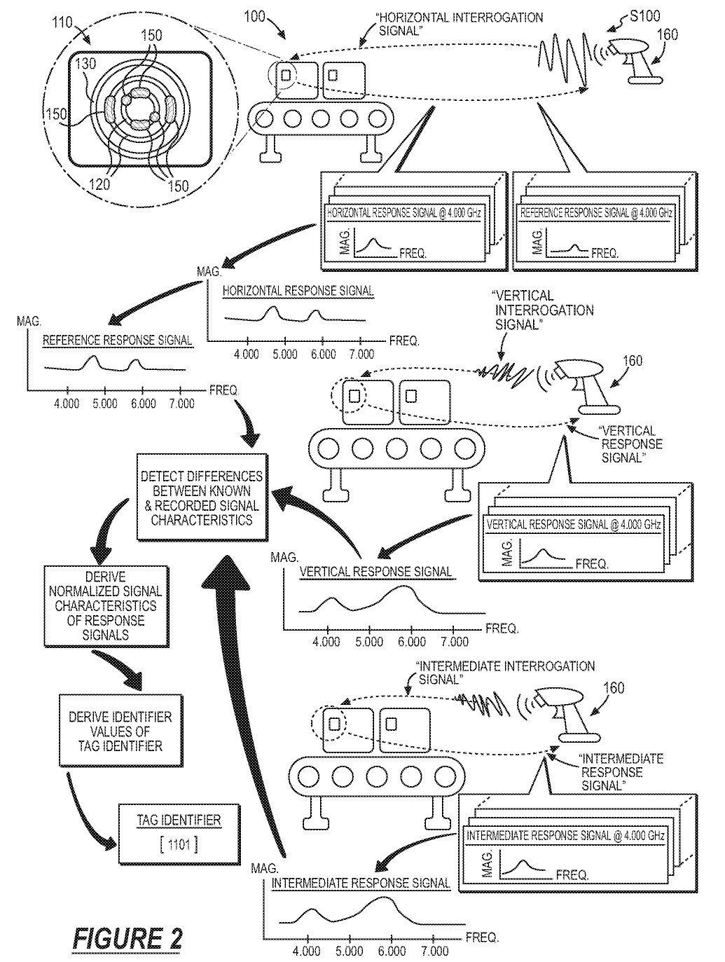

In one variation, as shown in FIG. 2, the identification tag 110 can include a target resonator 120 configured to encode identifier values at multiple polarization axes, such that the detector 160 can extract multiple independent identifier values from a single resonator. For example, the identification tag 110 can include multiple target resonators 120, each including volumes of material 150 arranged over arc segments intersecting multiple axes, such that each resonator encodes multiple independent identifier values. For example, the identification tag 110 can include a volume of material 150 arranged over an arc segment sized to intersect a polarization axis of the interrogation signal broadcast by the detector 160, such as between 20 degrees and 45 degrees, 60 degrees and 90 degrees, 90 degrees and 120 degrees, or between 100 degrees and 150 degrees of the target resonator 120. Furthermore, as described above, each volume of material 150 can exhibit a dimension, material composition, or arrangement configured to shift a signal characteristic of the response signal by a corresponding difference, the difference encoding an identifier value of the tag identifier.

In one example, the identification tag 110 can include a target resonator 120 including: a first volume of material 150 arranged over a first arc segment of the first target resonator 120 intersecting a first axis (e.g., a vertical axis); a second volume of material 150 arranged over a second arc segment of the first target resonator 120, the second arc segment opposite the first arc segment and intersecting the first axis (e.g., the vertical axis); a third volume of material 150 arranged over a third arc segment of the target resonator 120 intersecting a second axis (e.g., the horizontal axis); and a fourth volume of material 150 arranged over a fourth arc segment of the target resonator 120 intersecting the second axis (e.g., the horizontal axis). In particular, the first volume of material 150 and the second volume of material 150 cooperate to shift a first target signal characteristic (e.g., a resonant frequency) of a first target response signal (e.g., a horizontally-polarized response signal) from a first baseline signal characteristic of the target resonator 120. Additionally, the third volume of material 150 and the fourth volume of material 150 cooperate to shift a second target signal characteristic (e.g., a resonant frequency) of a second target response signal (e.g., a vertically-polarized response signal) from a second baseline signal characteristic of the target resonator 120.

Additionally, in this example, the detector 160 can derive a tag identifier of the identification tag 110 based on response signals received at both the first polarization and the second polarization. For example, the detector 160 can: implement methods and techniques described above to receive a horizontally-polarized response signal and a vertically-polarized response signal passively broadcast by the identification tag 110 responsive to excitation by a horizontally-polarized interrogation signal and a vertically-polarized interrogation signal, respectively; extract the first target signal characteristic from the horizontally-polarized response signal; and extract the second target signal characteristic from the vertically-polarized response signal. The detector 160 can then implement methods and techniques described above to derive a tag identifier of the identification tag 110 based on: the first target signal characteristic; and the second target signal characteristic.

In another example, the identification tag 110 includes a first target resonator 120 and a second target resonator 120. In this example, the first target resonator 120 can include a first volume of material 150 and a second volume of material 150 similar to the first volume of material 150 and the second volume of material 150 in the preceding example. The second target resonator 120 can include: a fifth volume of material 150 arranged over a fifth arc segment of the second target resonator 120 intersecting the second axis (e.g., the horizontal axis); and a sixth volume of material 150 arranged over a sixth arc segment of the second target resonator 120 intersecting the second axis (e.g., the horizontal axis) and cooperating with the fifth volume of material 150 to shift a third target signal characteristic of the second target response signal (e.g., the vertically-polarized response signal) from a third baseline signal characteristic of the second target resonator 120. In this example, the detector 160 can implement methods and techniques described above to: extract the first target signal characteristic from the horizontally-polarized response signal passively broadcast by the identification tag 110 responsive to excitation by the horizontally-polarized interrogation signal; extract the second target signal characteristic and the third target signal characteristic from the vertically-polarized response signal passively broadcast by the identification tag 110 responsive to excitation by the vertically-polarized interrogation signal; and derive a tag identifier of the identification tag 110 based on the first target signal characteristic, the second target signal characteristic, and the third target signal characteristic.

In another example, the identification tag 110 can include a target resonator 120 including: a first volume of material 150 arranged over a first arc segment of the first target resonator 120 intersecting a first axis (e.g., a vertical axis); a second volume of material 150 arranged over a second arc segment of the first target resonator 120, the second arc segment opposite the first arc segment and intersecting the first axis (e.g., the vertical axis); a third volume of material 150 arranged over a third arc segment of the target resonator 120 intersecting a second axis (e.g., the horizontal axis); a fourth volume of material 150 arranged over a fourth arc segment of the target resonator 120 intersecting the second axis (e.g., the horizontal axis); a fifth volume of material 150 arranged over a fifth arc segment of the target resonator 120 intersecting a third axis (e.g., an intermediate axis) offset from the first and second axes; and a sixth volume of material 150 arranged over a sixth arc segment, opposite the fifth arc segment, of the target resonator 120.

In particular, the first volume of material 150 and the second volume of material 150 cooperate to shift a first target signal characteristic (e.g., a resonant frequency) of a first target response signal (e.g., a horizontally-polarized response signal) from a first baseline signal characteristic of the target resonator 120. Additionally, the third volume of material 150 and the fourth volume of material 150 cooperate to shift a second target signal characteristic (e.g., a resonant frequency) of a second target response signal (e.g., a vertically-polarized response signal) from a second baseline signal characteristic of the target resonator 120. Furthermore, the fifth volume of material 150 and the sixth volume of material 150 cooperate to shift a third target signal characteristic of a third target response signal (e.g., an intermediate response signal) from a third baseline signal characteristic of the target resonator 120.

For example, the detector 160 can: implement methods and techniques described above to receive a horizontally-polarized response signal, a vertically-polarized response signal, and an intermediate response signal passively broadcast by the identification tag 110 responsive to excitation by a horizontally-polarized interrogation signal, a vertically-polarized interrogation signal, and an intermediate interrogation signal, respectively. The detector 160 can then: extract the first target signal characteristic from the horizontally-polarized response signal; extract the second target signal characteristic from the vertically-polarized response signal; extract the third target signal characteristic from the intermediate response signal; and derive a tag identifier of the identification tag 110 based on the first target signal characteristic, the second target signal characteristic, and the third target signal characteristic.

Thus, in the preceding examples, the identification tag 110 can include one or more target resonators 120, each including one or more volumes of material 150 arranged over arc segments intersecting multiple axes, and configured to encode independent identifier values in signal characteristics of the target response signals at each polarization. However, the identification tag 110 can include any quantity of discrete or concentrically-nested target resonators 120 (e.g., between one and ten), each including volumes of material 150 arranged over arc segments intersecting one or more axes, and configured to encode a tag identifier of a predefined bit length (e.g., 6 bits, 12 bits, 28 bits, 64 bits, 128 bits) in signal characteristics of the target response signals.

### 17.5 Concentric Resonator Spacing

In one variation, the set of concentrically-nested circular resonators can: be spaced to increase electromagnetic coupling between adjacent concentric resonators; and increase a reflection efficiency of an inner target resonator 120 (e.g., exhibiting a minimum radius and configured to resonate at a highest resonant frequency). In particular, an outer target resonator 120 can electromagnetically couple with an adjacent inner target resonator 120 to increase a reflection efficiency of the inner target resonator 120. More specifically, when the detector 160 broadcasts an interrogation signal at a frequency corresponding to an inner target resonator 120, the outer target resonator 120 (i.e., configured to resonate at a different, lower frequency) can increase the reflection efficiency of the inner target resonator 120 via electromagnetic coupling across a gap between the inner target resonator 120 and the outer target resonator 120, without altering the resonant frequency of the inner target resonator 120, such that the detector 160 can detect the response signal from the inner target resonator 120 at a higher amplitude.

In one example, the identification tag 110 can include: a first target resonator 120; a second target resonator 120; and a third target resonator 120. The first target resonator 120: exhibits a first radius; is configured to resonate at a first target resonant frequency; and is characterized by a first reflection efficiency at the first target resonant frequency. The second target resonator 120: exhibits a second radius greater than the first radius; is configured to resonate at a second target resonant frequency; is characterized by a second reflection efficiency at the second target resonant frequency; and is offset from the first target resonator 120 by a second distance to increase the first reflection efficiency of the first target resonator 120 toward a target reflection efficiency. The third target resonator 120: is arranged concentrically about the first target resonator 120 and the second target resonator 120; exhibits a third radius greater than the second radius; and is offset from the second target resonator 120 by a third distance, greater than the second distance, to increase the second reflection efficiency of the second target resonator 120 toward the target reflection efficiency. Accordingly, the detector 160 can detect the response signal from each target resonator 120 at the expected resonant frequency, unaffected by the coupling, and at a higher amplitude, increased by the coupling toward the target reflection efficiency.

### 18. Identification Tag with Multiple Identical Resonators

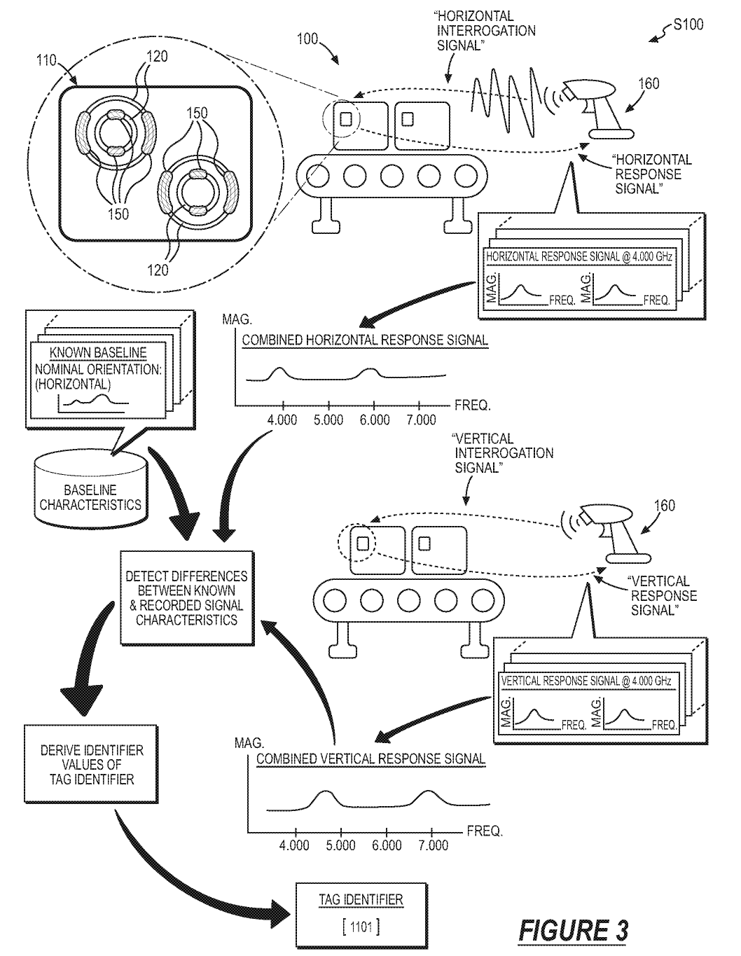

In one variation, as shown in FIG. 3, the identification tag 110 includes a set of identical resonator clusters arranged on the substrate. In particular, the identification tag 110 can include: a first resonator cluster including a first set of concentrically-nested resonators; and a second resonator cluster including a second set of concentrically-nested resonators identical to the first set of concentrically-nested resonators. The first resonator cluster and the second resonator cluster can be arranged on the same substrate in a non-concentric arrangement (e.g., adjacent on the substrate rather than nested).

For example, an identification tag 110 can include: a first target resonator 120 including a first volume of material 150; a second target resonator 120 arranged concentrically about the first target resonator 120 and including a second volume of material 150; a third target resonator 120 arranged on the substrate offset from the first target resonator 120 (i.e., non-concentric with the first and second target resonators 120) and identical to the first target resonator 120 (e.g., exhibiting the same characteristic layer pattern); and a fourth target resonator 120 arranged concentrically about the third target resonator 120 and identical to the second target resonator 120. In this example, the third target resonator 120 can cooperate with the first target resonator 120 to amplify a target response signal of the identification tag 110 toward a target power. Additionally, the fourth target resonator 120 can cooperate with the second target resonator 120 to amplify a target response signal of the identification tag 110 toward the target power.

Additionally, in this example, the detector 160 can derive a tag identifier of the identification tag 110 based on a composite of response signals received from the first resonator cluster and the second resonator cluster. For example, the detector 160 can: receive a first horizontally-polarized response signal passively broadcast by the identification tag 110 responsive to excitation of the first target resonator 120 and the second target resonator 120 by the horizontally-polarized interrogation signal; receive a first vertically-polarized response signal passively broadcast by the identification tag 110 responsive to excitation of the first target resonator 120 and the second target resonator 120 by the vertically-polarized interrogation signal; receive a second horizontally-polarized response signal passively broadcast by the identification tag 110 responsive to excitation of the third target resonator 120 and the fourth target resonator 120 by the horizontally-polarized interrogation signal; and receive a second vertically-polarized response signal passively broadcast by the identification tag 110 responsive to excitation of the third target resonator 120 and the fourth target resonator 120 by the vertically-polarized interrogation signal. The detector 160 can then: derive a combined horizontally-polarized response signal based on a composite of the first horizontally-polarized response signal and the second horizontally-polarized response signal; and derive a combined vertically-polarized response signal based on a composite of the first vertically-polarized response signal and the second vertically-polarized response signal. The detector 160 can then derive a tag identifier of the identification tag 110 based on: signal characteristics of the combined horizontally-polarized response signal; and signal characteristics of the combined vertically-polarized response signal.

For example, the detector 160 can average the first horizontally-polarized response signal and the second horizontally-polarized response signal to derive the combined horizontally-polarized response signal, such that inconsistencies in the response signal of either resonator cluster — such as those resulting from variation in material deposition or environmental noise — are smoothed across the combined horizontally-polarized response signal. The detector 160 can then repeat this process to derive the combined vertically-polarized response signal.

Thus, in this variation, the first resonator cluster and the second resonator cluster cooperate to amplify an amplitude of a combined response signal broadcast by the identification tag 110. In particular, when the detector 160 broadcasts an interrogation signal, both the first resonator cluster and the second resonator cluster broadcast response signals at corresponding resonant frequencies such that the detector 160 receives a combined response signal exhibiting a higher amplitude than a response signal from either resonator cluster. Accordingly, the identification tag 110 can include multiple identical resonator clusters to increase a signal power of the response signal, such that the detector 160 can detect the identification tag 110 at a greater distance or with higher signal-to-noise ratio.

In another variation, the first resonator cluster and the second resonator cluster are arranged on separate substrates and positioned at different locations on an object. For example, the identification tag 110 can include three separate substrates, each containing one resonator cluster, and each substrate can adhere to a different surface of a manufacturing tote. The detector 160 can then: interrogate each resonator cluster independently or simultaneously; receive response signals from each resonator cluster; and compile the response signals into a tag identifier. For example, the detector 160 can average the response signals from the resonator clusters to reduce noise and improve accuracy of the tag identifier.

In one variation, the detector 160 can access images captured by an optical sensor (e.g., located proximal the detector 160) to detect a position of each resonator cluster on the object. In particular, the detector 160 can: identify a first resonator cluster at a first position on the object; identify a second resonator cluster at a second position on the object; sequentially interrogate each resonator cluster; and compile the response signals from each resonator cluster into a tag identifier based on a predefined ordering of the resonator clusters corresponding to the positions of the resonator clusters on the object.

### 19. Identification Tag with Multiple Non-identical Resonators

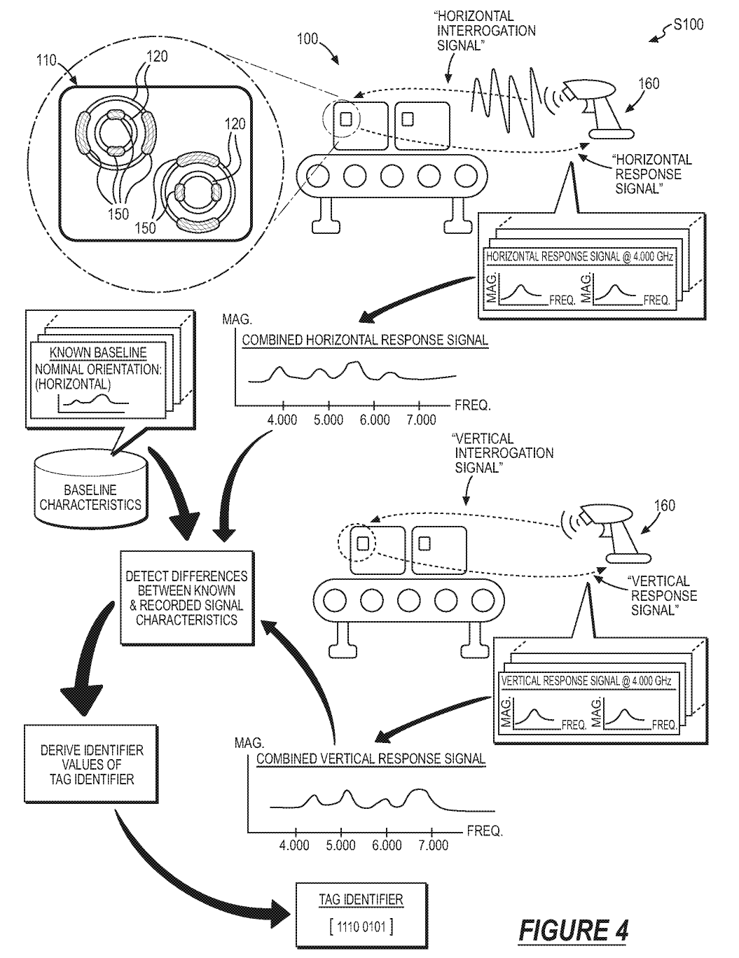

In one variation, as shown in FIG. 4, the identification tag 110 includes a set of non-identical resonator clusters arranged on the substrate. In one example, the identification tag 110 can include: a first resonator cluster including a first set of concentrically-nested resonators configured with a first characteristic layer pattern; and a second resonator cluster including a second set of concentrically-nested resonators configured with a second characteristic layer pattern different from the first characteristic layer pattern. The first resonator cluster and the second resonator cluster can be arranged on the same substrate in a non-concentric arrangement.

In this variation, the detector 160 can: broadcast interrogation signals over the band of interrogation frequencies; receive response signals from multiple non-identical resonator clusters; identify distinct sets of resonant frequencies corresponding to each resonator cluster; and independently interpret identifier values from each set of resonant frequencies. The detector 160 can then compile the identifier values from all resonator clusters into a tag identifier associated with the identification tag 110.

For example, in the preceding example, the detector 160 can: receive a first horizontally-polarized response signal passively broadcast by the identification tag 110 responsive to excitation of the first target resonator 120 and the second target resonator 120 by the horizontally-polarized interrogation signal; receive a first vertically-polarized response signal passively broadcast by the identification tag 110 responsive to excitation of the first target resonator 120 and the second target resonator 120 by the vertically-polarized interrogation signal; receive a second horizontally-polarized response signal passively broadcast by the identification tag 110 responsive to excitation of the third target resonator 120 and the fourth target resonator 120 by the horizontally-polarized interrogation signal; and receive a second vertically-polarized response signal passively broadcast by the identification tag 110 responsive to excitation of the third target resonator 120 and the fourth target resonator 120 by the vertically-polarized interrogation signal. The detector 160 can then implement methods and techniques described above to derive a tag identifier of the identification tag 110 based on unique signal characteristics of: the first horizontally-polarized response signal; the first vertically-polarized response signal; the second horizontally-polarized response signal; and the second vertically-polarized response signal.

In particular, in this example, the first resonator cluster (i.e., the first and second target resonators 120) encodes a first set of identifier values, and the second resonator cluster (i.e., the third and fourth target resonators 120) encodes a second set of identifier values different from the first set of identifier values. The detector 160 can: interrogate the first resonator cluster and the second resonator cluster; interpret the first set of identifier values from the first resonator cluster; interpret the second set of identifier values from the second resonator cluster; and compile the first set of identifier values and the second set of identifier values into a tag identifier. Accordingly, the identification tag 110 can encode a greater quantity of identifier values by distributing identifier values across multiple non-identical resonator clusters.

In one variation, each non-identical resonator cluster is arranged at a different position on the object, and the detector 160 compiles the identifier values from each resonator cluster in a predefined order corresponding to the positions of the resonator clusters on the object. The tag identifier can thus include a first portion corresponding to the first resonator cluster and a second portion corresponding to the second resonator cluster.

### 20. Handshake Resonators

In one variation, the identification tag 110 includes a handshake resonator configured to output signal responses that: indicate the orientation of the identification tag 110 relative to the detector 160; or otherwise indicate which legs of resonators in the nested set of resonators will resonate responsive to each polarized signal broadcast by the detector 160. In particular, the handshake resonator can indicate the physical orientation of the identification tag 110 (i.e., on an object) such that each detected resonant frequency is accurately mapped to the corresponding pair of legs and correctly ordered within the tag identifier.

More specifically, a target resonator 120 is configured to resonate at a target resonant frequency, and one or more volumes of material 150 can cooperate to shift a target signal characteristic of a first response signal of the target resonator 120 while the identification tag 110 occupies a nominal orientation. Accordingly, the detector 160 can: receive response signals (e.g., a horizontally-polarized response signal and a vertically-polarized response signal) passively broadcast by the identification tag 110; and, in response to detecting the target signal characteristic at the target resonant frequency in a second response signal, different from the first response signal, detect a real orientation, offset from the nominal orientation, of the identification tag 110. The detector 160 can then derive the tag identifier of the identification tag 110 based on: signal characteristics of the response signals; and the real orientation.

In one example, the handshake resonator can include a predefined (i.e., known) configuration of dielectric material arranged over the pair of horizontal legs, such that the detector 160 can infer the physical orientation of the identification tag 110 based on observation of a frequency shift in the vertical or horizontally-polarized response signal. For example, the identification tag 110 can include a first target resonator 120 configured to resonate at a baseline resonant frequency. The identification tag 110 can further include: a first volume of material 150 arranged over a pair of horizontal legs of the first target resonator 120 and configured to shift the baseline resonant frequency of the vertically-polarized response signal by a first difference; and a second volume of material 150 arranged over a pair of vertical legs of the first target resonator 120 and configured to shift the baseline resonant frequency of the horizontally-polarized response signal by a second difference different from the first difference.

In this example, the detector 160 broadcasts a first vertically-polarized interrogation signal in a vertical orientation (i.e., at a first incident angle). In response to detecting a vertically-polarized response signal at a first resonant frequency (i.e., equal to the baseline resonant frequency plus the first shift), the detector 160 identifies that the horizontal legs (overlaid with the first volume of material 150) are aligned horizontally relative to the detector 160. More specifically, the detector 160 infers that the vertically-polarized interrogation signal is correctly polarized to excite the pair of horizontal legs, and that the identification tag 110 is oriented within a roll angle between +45° and −45° relative to the detector 160. Alternatively, in response to detecting the vertical response at a second resonant frequency (i.e., equal to the baseline resonant frequency plus the second shift), the detector 160 identifies that the vertical legs (overlaid with the second volume of material 150) are horizontally aligned relative to the detector 160. More specifically, the detector 160 infers that the vertically-polarized interrogation signal is coupling to the pair of vertical legs, and that the identification tag 110 is oriented within a roll angle between +45° and +135°.

Thus, the detector 160 can infer which polarization output of the detector 160 (vertical or horizontal) excites the vertical legs and which polarization output of the detector 160 excites the horizontal legs, based on the unique frequency shift associated with each pair of legs. The detector 160 can then interpret the physical orientation of the tag to resolve the correct bit-ordering schema for ordering a first set of identifiers interpreted from the horizontally-polarized response signal and a second set of identifiers interpreted from the vertically-polarized response signal (i.e., which set of identifiers to place first and which to place second when assembling the complete tag identifier).

In one example, an identification tag 110 includes: a first square resonator tuned to an initial resonant frequency of 3.000 GHz; a second handshake resonator (i.e., a square resonator encompassing the first square resonator) tuned to an initial resonant frequency of 2.500 GHz; and a volume of material 150 arranged on the substrate proximal horizontal legs of the second handshake resonator and configured to shift the vertical resonant frequency of the second square resonator to 2.400 GHz. In this example, the detector 160 interrogates the identification tag 110 over an interrogation band between 2.300 GHz and 3.100 GHz (e.g., in 0.001 GHz increments).

The detector 160 then: detects a first horizontal resonant frequency at 2.400 GHz and a second horizontal resonant frequency at 3.000 GHz in the horizontally-polarized response signal (i.e., responsive to broadcast of a horizontally-polarized interrogation signal); and detects a first vertical resonant frequency at 2.500 GHz and a second vertical resonant frequency at 3.000 GHz in the vertically-polarized response signal (i.e., responsive to broadcast of a vertically-polarized interrogation signal). In response to detecting the “shifted” resonant frequency at 2.400 GHz in the horizontally-polarized response signal, the detector 160 identifies an offset orientation (i.e., with the pair of horizontal legs oriented vertically or perpendicular to the ground surface) of the identification tag 110. More specifically, the detector 160 identifies the offset orientation based on the known configuration of dielectric material arranged over the horizontal legs of the handshake resonator (i.e., where a frequency shift is expected in the vertically-polarized response signal) and detection of the shifted frequency in the horizontally-polarized response signal, thereby indicating that the horizontal legs are aligned vertically with respect to the interrogation signals.

Upon detecting the orientation of the identification tag 110, the detector 160 can: implement methods and techniques described above to detect horizontal and vertical resonant frequencies of each resonator in the identification tag 110; and interpret the tag identifier based on the orientation of the identification tag 110 to assemble the components of the tag identifier in the correct order (i.e., not mirrored or reversed due to the mounting orientation). Thus, the detector 160 can associate each detected resonant frequency with the correct positional and directional context, thereby preventing errors in bit assignment when detecting identification tags 110 mounted in unknown or inconsistent orientations.

### 21. Reference Resonators

In one variation, the identification tag 110 can further include a set of (i.e., one or more) reference resonators 130 devoid of dielectric material and configured to return reference signals when interrogated by the detector 160. In particular, a reference resonator 130 can be devoid of dielectric material such that a reference signal, returned by the reference resonator 130 when interrogated, is affected by the cover layer and/or external objects near the identification tag 110 and the detector 160.

For example, the identification tag 110 can include: a first resonator (e.g., a circular resonator) arranged on the substrate; a second resonator arranged concentrically about (e.g., encompassing) the first resonator; and a reference resonator 130 (e.g., a circular resonator) arranged concentrically about (e.g., encompassing) the second resonator. In this example, the reference resonator 130 can be: characterized by a set of baseline reference signal characteristics; and configured to broadcast a reference horizontally-polarized response signal responsive to excitation by the horizontally-polarized interrogation signal.

In this example, the detector 160 can: receive the reference horizontally-polarized response signal, the horizontally-polarized response signal, and the vertically-polarized response signal from the identification tag 110 responsive to excitation by the horizontally-polarized interrogation signal; extract a first set of real reference signal characteristics from the reference horizontally-polarized response signal; detect a difference between the set of baseline reference signal characteristics and the first set of real reference signal characteristics; extract a second set of target signal characteristics from the horizontally-polarized response signal; and derive a third set of normalized signal characteristics of the horizontally-polarized response signal based on the second set of target signal characteristics and the difference between the set of baseline reference signal characteristics and the first set of real reference signal characteristics. The detector 160 can then repeat this process to derive a fourth set of normalized signal characteristics of the vertically-polarized response signal based on a fifth set of target signal characteristics of the vertically-polarized response signal and the difference between the set of baseline reference signal characteristics and the first set of real reference signal characteristics. The detector 160 can then derive a tag identifier of the identification tag 110 based on the third set of normalized signal characteristics and the fourth set of normalized signal characteristics.

In another example, an identification tag 110 includes: a first reference resonator 130 (i.e., a square resonator) tuned to a first initial frequency proximal a lower boundary of the interrogation band; a second reference resonator 130 (i.e., a square resonator) tuned to a second initial frequency proximal an upper boundary of the interrogation band; a third resonator (i.e., a square resonator) arranged between the first and second reference resonators 130 and tuned to a third initial frequency between the first and second initial frequencies; and a volume of material 150 arranged on the substrate proximal vertical legs of the third resonator and configured to shift the horizontal resonant frequency of the third resonator.

In this example, the detector 160 can: interrogate the identification tag 110 (i.e., broadcast interrogation signals) over an interrogation band; detect a first horizontal reference frequency corresponding to the first reference resonator 130; detect a second horizontal reference frequency corresponding to the second reference resonator 130; detect a third horizontal resonant frequency corresponding to the third resonator; and calibrate (or “normalize”) the third horizontal resonant frequency based on a first difference between the first initial frequency and the first reference frequency and a second difference between the second initial frequency and the second reference frequency.

For example, the detector 160 can normalize the third horizontal resonant frequency based on a function relating the first difference and the second difference. Alternatively, the detector 160 can normalize the third resonant frequency by interpolating between the first difference and the second difference. Furthermore, the detector 160 can repeat this process to normalize a third vertical resonant frequency broadcast by the identification tag 110. The detector 160 can then implement methods and techniques described above to interpret a tag identifier associated with the identification tag 110 based on the normalized resonant frequencies. Thus, given a priori information regarding characteristics of the reference resonators 130 (e.g., initial resonant frequencies), the detector 160 can correct (or “normalize”) response signals returned by other resonators when interrogated by the detector 160.

### 22. N-polygonal-resonator Identification Tag

In one variation, the identification tag 110 can include a set of (i.e., one or more) concentrically-nested, polygonal resonators, such as hexagonal resonators, octagonal resonators, dodecagonal, or circular resonators. In particular, each polygonal resonator can define a greater number of leg orientations and corresponding field-coupling paths than a square resonator, thus increasing a quantity of bits encoded into the tag identifier by each resonator (e.g., relative to a square resonator). Each leg of a particular polygonal resonator can define a leg length less than a diameter of a volume of material 150, such that: each discrete volume of material 150 does not overlap with adjacent dielectric volumes; each leg can be individually excited by a corresponding interrogation signal; and the detector 160 can resolve a distinct response signal corresponding to each pair of legs. Thus, the identification tag 110 can include polygonal resonators configured to store a greater quantity of bits per resonator (e.g., relative to a square resonator).

### 22.3 Hexagonal Resonator

In one variation, the identification tag 110 can include a hexagonal resonator including: a pair of horizontal legs; a first pair of diagonal legs; and a second pair of diagonal legs. In one example, the identification tag 110 can include: a first hexagonal resonator tuned to a first initial frequency of 5.111 GHz; a second hexagonal resonator encompassing the first hexagonal resonator and tuned to a second initial frequency of 4.121 GHz; a first volume of material 150 arranged proximal the pair of horizontal legs and configured to shift a first vertical resonant frequency from 5.111 GHz to 5.011 GHz; and a second volume of material 150 arranged proximal the first pair of diagonal legs and configured to shift a second diagonal resonant frequency from 4.121 GHz to 4.101 GHz.

In this example, the detector 160 interrogates the identification tag 110 over an interrogation band between 3.900 GHz and 5.200 GHz (e.g., in 0.001 GHz increments). In particular, the detector 160 broadcasts interrogation signals over the interrogation band in multiple field orientations, such as: a vertical orientation (e.g., aligned with the horizontal legs of the resonators); a first diagonal orientation (e.g., a 60° orientation aligned with the first pair of diagonal legs); and a second diagonal orientation (e.g., a 120° orientation aligned with the second pair of diagonal legs).

The detector 160 then implements methods and techniques described above to: detect each resonant frequency (e.g., 5.011 GHz, 4.101 GHz, 4.121 GHz) in the response signal; and interpret a tag identifier associated with the identification tag 110, such as by assigning binary identifiers to the resonant frequencies based on the presence or absence of frequency shifts and/or assigning frequency identifiers to the resonant frequencies based on the corresponding frequency subrange.

### 22.4 Octagonal Resonator

In one variation, as shown in FIG. 6C, the identification tag 110 can include an octagonal resonator including: a pair of vertical legs; a pair of horizontal legs; a first pair of diagonal legs; and a second pair of diagonal legs. In this variation, to interrogate the identification tag 110, the detector 160 can broadcast interrogation signals over an interrogation band in multiple field orientations, such as: a horizontal orientation (e.g., aligned with the vertical legs); a vertical orientation (e.g., aligned with the horizontal legs); a first diagonal orientation (e.g., a +45° orientation aligned with the first pair of diagonal legs); and a second diagonal orientation (e.g., a -45° orientation aligned with the second pair of diagonal legs).

The detector 160 can then implement methods and techniques described above to: detect each resonant frequency in the response signal broadcast by the identification tag 110; and interpret a tag identifier associated with the identification tag 110, such as by assigning binary identifiers to the resonant frequencies based on the presence or absence of frequency shifts and/or assigning frequency identifiers to the resonant frequencies based on the corresponding frequency subrange.

### 23. Interrogation with Fixed Position and Stepped Frequency

In one variation, the detector 160 can execute an interrogation cycle with a fixed interrogation position or orientation and a stepped interrogation frequency. For example, the detector 160 can include: an ellipsoidal antenna configured to broadcast a wide polarization profile from a fixed point; an articulating antenna configured to maintain a fixed position while adjusting polarization over time; or a solid-state phase array configured to control the angular phase profile of broadcast signals electronically without physical movement. In particular, the detector 160 can: broadcast interrogation signals at a first frequency (e.g., 4.100 GHz) while sweeping through a range of orientations (e.g., a full 360-degree revolution); and, in response to completing the orientation sweep at the first frequency, switch to a second frequency (e.g., 4.101 GHz); and broadcast interrogation signals at the second frequency (e.g., 4.101 GHz) through the range of orientations. The detector 160 can then repeat this process to scan the range of orientations at each frequency (e.g., in 0.001 GHz increments) in the interrogation band. Thus, by sweeping through a continuous set of field orientations at each interrogation frequency, the detector 160 can detect resonant responses from identification tags 110 including complex resonator geometries (e.g., polygonal resonators).

### 24. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
an identification tag:
configured to:
broadcast a horizontally-polarized response signal responsive to excitation by a horizontally-polarized interrogation signal; and
broadcast a vertically-polarized response signal responsive to excitation by a vertically-polarized interrogation signal; and
comprising:
a first target resonator comprising:
a first arc segment intersecting a vertical axis;
a second arc segment:
opposite the first arc segment; and
intersecting the vertical axis;
a first volume of material arranged proximal the first arc segment; and
a second volume of material:
arranged proximal the second arc segment; and
configured to cooperate with the first volume of material to shift a first target signal characteristic of the horizontally-polarized response signal from a first baseline signal characteristic of the first target resonator; and
a second target resonator:
arranged concentrically about the first target resonator; and
comprising:
a third arc segment intersecting a horizontal axis;
a fourth arc segment:
opposite the third arc segment;and
intersecting the horizontal axis;
a third volume of material arranged proximal the third arc segment; and
a fourth volume of material:
arranged proximal the fourth arc segment; and
configured to cooperate with the third volume of material to shift a second target signal characteristic of the vertically-polarized response signal from a second baseline signal characteristic of the second target resonator.

2. The system of claim 1, further comprising a detector configured to:
broadcast the horizontally-polarized interrogation signal;
broadcast the vertically-polarized interrogation signal;
receive the horizontally-polarized response signal passively broadcast by the identification tag responsive to excitation of the first arc segment and the second arc segment of the first target resonator and a fifth arc segment and a sixth arc segment, intersecting the vertical axis, of the second target resonator by the horizontally-polarized interrogation signal;
receive the vertically-polarized response signal passively broadcast by the identification tag responsive to excitation of the third arc segment and the fourth arc segment of the second target resonator and a seventh arc segment and an eighth arc segment, intersecting the horizontal axis, of the first target resonator by the vertically-polarized interrogation signal; and
derive a tag identifier of the identification tag based on:
a first set of signal characteristics of the horizontally-polarized response signal; and
a second set of signal characteristics of the vertically-polarized response signal.

3. The system of claim 1:
wherein the second volume of material is configured to cooperate with the first volume of material to shift the first target signal characteristic from the first baseline signal characteristic by a first difference that encodes a first identifier value in a first set of identifier values corresponding to a tag identifier of the identification tag; and
further comprising a detector configured to:
receive the horizontally-polarized response signal passively broadcast by the identification tag responsive to excitation by the horizontally-polarized interrogation signal;
extract a first set of signal characteristics from the horizontally-polarized response signal;
detect the first difference between the first target signal characteristic and the first baseline signal characteristic;
derive the first identifier value of a tag identifier of the identification tag based on the first difference; and
aggregate the first identifier value with identifier values encoded in each signal characteristic in the first set of signal characteristics to identify the identification tag.

4. The system of claim 1:
wherein the first target resonator comprises a first conductive circular resonator exhibiting a first radius;
wherein the second target resonator comprises a second conductive circular resonator:
arranged concentrically about the first conductive circular resonator; and
exhibiting a second radius greater than the first radius; and
wherein the first arc segment, the second arc segment, the third arc segment, and the fourth arc segment span an arc length between 60 degrees and 90 degrees.

5. The system of claim 1:
wherein the first target resonator:
exhibits a first radius;
is configured to resonate at a first target resonant frequency; and
is characterized by a first reflection efficiency at the first target resonant frequency;
wherein the second target resonator:
exhibits a second radius greater than the first radius;
is configured to resonate at a second target resonant frequency;
is offset from the first target resonator by a second distance to increase the first reflection efficiency of the first target resonator toward a target reflection efficiency; and
wherein the identification tag further comprises a third target resonator:
arranged concentrically about the first target resonator and the second target resonator;
exhibiting a third radius greater than the second radius; and
offset from the second target resonator by a third distance, greater than the second distance, to increase the second reflection efficiency of the second target resonator toward the target reflection efficiency.

6. The system of claim 1:
wherein the identification tag further comprises a reference resonator:
arranged concentrically about the first target resonator and the second target resonator;
devoid of volumes of material;
characterized by a set of baseline reference signal characteristics; and
configured to broadcast a reference horizontally-polarized response signal responsive to excitation by the horizontally-polarized interrogation signal; and
further comprising a detector configured to:
receive the reference horizontally-polarized response signal and the horizontally-polarized response signal from the identification tag responsive to excitation by the horizontally-polarized interrogation signal;
extract a first set of real reference signal characteristics from the reference horizontally-polarized response signal;
detect a difference between the set of baseline reference signal characteristics and the first set of real reference signal characteristics;
extract a second set of target signal characteristics from the horizontally-polarized response signal;
derive a third set of normalized signal characteristics of the horizontally-polarized response signal based on:
the second set of target signal characteristics; and
the difference between the set of baseline reference signal characteristics and the first set of real reference signal characteristics; and
derive a tag identifier of the identification tag based on the third set of normalized signal characteristics.

7. The system of claim 1:
wherein the first target resonator further comprises:
a fifth arc segment intersecting the horizontal axis;
a sixth arc segment:
opposite the fifth arc segment; and
a fifth volume of material arranged proximal the fifth arc segment; and
intersecting the horizontal axis;
a sixth volume of material:
arranged proximal the sixth arc segment; and
configured to cooperate with the fifth volume of material to shift a third target signal characteristic of the vertically-polarized response signal from a third baseline signal characteristic of the first target resonator; and
further comprising a detector configured to:
extract the first target signal characteristic from the horizontally-polarized response signal passively broadcast by the identification tag responsive to excitation by the horizontally-polarized interrogation signal;
extract the second target signal characteristic and the third target signal characteristic from the vertically-polarized response signal passively broadcast by the identification tag responsive to excitation by the vertically-polarized interrogation signal; and
derive a tag identifier of the identification tag based on:
the first target signal characteristic;
the second target signal characteristic; and
the third target signal characteristic.

8. The system of claim 1:
wherein the identification tag is further configured to broadcast an intermediate response signal responsive to excitation by an intermediate interrogation signal;
wherein the first target resonator further comprises:
a fifth arc segment intersecting an intermediate axis offset from the vertical axis and the horizontal axis;
a sixth arc segment:
opposite the fifth arc segment; and
intersecting the intermediate axis;
a fifth volume of material arranged proximal the fifth arc segment; and
a sixth volume of material:
arranged proximal the sixth arc segment; and
configured to cooperate with the fifth volume of material to shift a third target signal characteristic of the intermediate response signal from a third baseline signal characteristic of the first target resonator; and
further comprising a detector configured to:
extract the first target signal characteristic from the horizontally-polarized response signal passively broadcast by the identification tag responsive to excitation by the horizontally-polarized interrogation signal;
extract the second target signal characteristic from the vertically-polarized response signal passively broadcast by the identification tag responsive to excitation by the vertically-polarized interrogation signal;
extract the third target signal characteristic from the intermediate response signal passively broadcast by the identification tag responsive to excitation by the intermediate interrogation signal; and
derive a tag identifier of the identification tag based on:
the first target signal characteristic;
the second target signal characteristic; and
the third target signal characteristic.

9. The system of claim 1, wherein the identification tag further comprises:
a substrate;
a third target resonator:
arranged on the substrate offset from the first target resonator;
comprising:
a fifth volume of material arranged proximal a fifth arc segment intersecting the vertical axis; and
a sixth volume of material arranged proximal a sixth arc segment, opposite the fifth arc segment, intersecting the vertical axis; and
cooperating with the first target resonator to amplify the horizontally-polarized response signal toward a target power; and
a fourth target resonator:
arranged concentrically about the third target resonator;
comprising:
a seventh volume of material arranged proximal a seventh arc segment intersecting the horizontal axis; and
an eighth volume of material arranged proximal an eighth arc segment, opposite the seventh arc segment, intersecting the horizontal axis; and
cooperating with the second target resonator to amplify the vertically-polarized response signal toward the target power.

10. The system of claim 9, further comprising a detector configured to:
receive the horizontally-polarized response signal passively broadcast by the identification tag responsive to excitation of the first target resonator and the second target resonator by the horizontally-polarized interrogation signal;
receive a third horizontally-polarized response signal passively broadcast by the identification tag responsive to excitation of the third target resonator and the fourth target resonator by the horizontally-polarized interrogation signal;
receive the vertically-polarized response signal passively broadcast by the identification tag responsive to excitation of the first target resonator and the second target resonator by the vertically-polarized interrogation signal;
receive a third vertically-polarized response signal passively broadcast by the identification tag responsive to excitation of the third target resonator and the fourth target resonator by the vertically-polarized interrogation signal;
derive a combined horizontally-polarized response signal based on a composite of the horizontally-polarized response signal and the third horizontally-polarized response signal;
derive a combined vertically-polarized response signal based on a composite of the vertically-polarized response signal and the third vertically-polarized response signal; and
derive a tag identifier of the identification tag based on:
the combined horizontally-polarized response signal; and
the combined vertically-polarized response signal.

11. The system of claim 1:
wherein the identification tag further comprises:
a substrate;
a third target resonator arranged on the substrate offset from the first target resonator; and
a fourth target resonator arranged concentrically about the third target resonator; and
further comprising a detector configured to:
receive the horizontally-polarized response signal passively broadcast by the identification tag responsive to excitation of the first target resonator and the second target resonator by the horizontally-polarized interrogation signal;
receive a third horizontally-polarized response signal passively broadcast by the identification tag responsive to excitation of the third target resonator and the fourth target resonator by the horizontally-polarized interrogation signal;
receive the vertically-polarized response signal passively broadcast by the identification tag responsive to excitation of the first target resonator and the second target resonator by the vertically-polarized interrogation signal;
receive a third vertically-polarized response signal passively broadcast by the identification tag responsive to excitation of the third target resonator and the fourth target resonator by the vertically-polarized interrogation signal; and
derive a tag identifier of the identification tag based on:
the horizontally-polarized response signal;
the vertically-polarized response signal;
the third horizontally-polarized response signal; and
the third vertically-polarized response signal.

12. The system of claim 1:
wherein the second target resonator is configured to resonate at a second target resonant frequency;
wherein the third volume of material and the fourth volume of material are configured to cooperate to shift the second target signal characteristic of the vertically-polarized response signal while the identification tag occupies a nominal orientation; and
further comprising a detector configured to:
receive the horizontally-polarized response signal and the vertically-polarized response signal passively broadcast by the identification tag;
in response to detecting the second target signal characteristic at the second target resonant frequency in the horizontally-polarized response signal, detect a real orientation, offset from the nominal orientation, of the identification tag; and
derive a tag identifier of the identification tag based on:
a first set of signal characteristics of the horizontally-polarized response signal;
a second set of signal characteristics of the vertically-polarized response signal; and
the real orientation.

13. The system of claim 1:
wherein a first dimension of the first volume of material and the second volume of material corresponds to a first difference between the first baseline signal characteristic and the first target signal characteristic, the first difference encoding a first identifier value corresponding to a tag identifier of the identification tag; and wherein a third dimension of the third volume of material and the fourth volume of material corresponds to a second difference between the second baseline signal characteristic and the second target signal characteristic, the second difference encoding a second identifier value forming the tag identifier in combination with the first identifier value.

14. The system of claim 1:
wherein a first material of the first volume of material and the second volume of material corresponds to a first difference between the first baseline signal characteristic and the first target signal characteristic, the first difference encoding a first identifier value corresponding to a tag identifier of the identification tag; and
wherein a second material of the third volume of material and the fourth volume of material corresponds to a second difference between the second baseline signal characteristic and the second target signal characteristic, the second difference encoding a second identifier value forming the tag identifier in combination with the first identifier value.

15. A system comprising:
an identification tag comprising:
a first target resonator comprising:
a first arc segment intersecting a first axis;
a second arc segment:
opposite the first arc segment; and
intersecting the first axis;
a first volume of material arranged proximal the first arc segment; and
a second volume of material:
arranged proximal the second arc segment; and
cooperating with the first volume of material to shift a first baseline signal characteristic of the first target resonator; and o a second target resonator:
arranged concentrically about the first target resonator; and
comprising:
a third arc segment intersecting a second axis angularly offset from the first axis;
a fourth arc segment:
opposite the third arc segment; and
intersecting the second axis;
a third volume of material arranged proximal the third arc segment; and
a fourth volume of material:
arranged proximal the fourth arc segment; and
cooperating with the third volume of material to shift a second baseline signal characteristic of the second target resonator.

16. The system of claim 15, further comprising a detector configured to:
receive a first target response signal from the identification tag, the first target response signal passively broadcast by the identification tag responsive to excitation of the first target resonator and the second target resonator by a first interrogation signal;
receive a second target response signal from the identification tag, the second target response signal passively broadcast by the identification tag responsive to excitation of the first target resonator and the second target resonator by a second interrogation signal;
extract a first target signal characteristic from the first target response signal, the first target signal characteristic shifted from the first baseline signal characteristic by a first difference that encodes a first identifier value of a tag identifier of the identification tag;
extract a second target signal characteristic from the second target response signal, the second target signal characteristic shifted from the second baseline signal characteristic by a second difference that encodes a second identifier value of the tag identifier; and
aggregate the first identifier value and the second identifier value to identify the identification tag.

17. The system of claim 15:
wherein the first axis comprises a vertical axis;
wherein the second axis comprises a horizontal axis orthogonal to the vertical axis;
wherein the first volume of material and the second volume of material cooperate to shift a first target signal characteristic of a horizontally-polarized response signal, passively broadcast by the identification tag responsive to excitation by a horizontally-polarized interrogation signal, from the first baseline signal characteristic of the first target resonator; and
wherein the third volume of material and the fourth volume of material cooperate to shift a second target signal characteristic of a vertically-polarized response signal, passively broadcast by the identification tag responsive to excitation by a vertically-polarized interrogation signal, from the second baseline signal characteristic of the second target resonator.

18. The system of claim 17, wherein the first target resonator further comprises:
a fifth arc segment intersecting an intermediate axis angularly offset from the vertical axis and the horizontal axis;
a sixth arc segment:
opposite the fifth arc segment; and
intersecting the intermediate axis;
a fifth volume of material arranged proximal the fifth arc segment; and
a sixth volume of material:
arranged proximal the sixth arc segment; and
cooperating with the fifth volume of material to shift a third baseline signal characteristic of the first target resonator.

19. The system of claim 15:
wherein a first material of the first volume of material and the second volume of material corresponds to a first difference between the first baseline signal characteristic and the first target signal characteristic, the first difference encoding a first identifier value corresponding to a tag identifier of the identification tag; and
wherein a second material of the third volume of material and the fourth volume of material corresponds to a second difference between the second baseline signal characteristic and the second target signal characteristic, the second difference encoding a second identifier value forming the tag identifier in combination with the first identifier value.

20. An identification tag:
configured to:
broadcast a first response signal responsive to excitation by a first interrogation signal at a first incident angle; and
broadcast a second response signal responsive to excitation by a second interrogation signal at a second incident angle different from the first incident angle; and
comprising a target resonator comprising:
a first volume of material arranged proximal a first arc segment of the target resonator, the first arc segment intersecting a first axis;
a second volume of material:
arranged proximal a second arc segment of the target resonator, the second arc segment intersecting the first axis; and §
configured to cooperate with the first volume of material to shift a first target signal characteristic of the first response signal from a first baseline signal characteristic of the target resonator;
a third volume of material arranged proximal a third arc segment of the target resonator, the third arc segment intersecting a third axis offset from the first axis; and
a fourth volume of material:
arranged proximal a fourth arc segment of the target resonator, the fourth arc segment intersecting the third axis; and
configured to cooperate with the third volume of material to shift a second target signal characteristic of the second response signal from a second baseline signal characteristic of the target resonator.
